(19) United States
(12) Patent Application Publication
(10) Pub. No.: US 2022/0324555 A1
(43) Pub. Date: Oct. 13, 2022

(54) AIRCRAFT AIRFOILS INCLUDING WAVE ASSEMBLIES, SYSTEMS INCLUDING WAVE ASSEMBLIES, AND METHODS OF USING THE SAME

(71) Applicants: THE TEXAS A&M UNIVERSITY SYSTEM, College Station, TX (US); Research Foundation of Suny, Albany, NY (US)

(72) Inventors: Iman Borazjiani, College Station, TX (US); M. Karami, Buffalo, NY (US)

(21) Appl. No.: 17/621,038

(22) PCT Filed: Jun. 19, 2020
(86) PCT No.: PCT/US2020/038771

§ 371 Date: Dec. 20, 2021

Related U.S. Application Data
(60) Provisional application No. 62/863,365, filed on Jun. 19, 2019.

(51) Int. Cl. B64C 21/10; B64C 13/50; B64C 3/14

(52) U.S. Cl. CPC B64C 21/10; B64C 13/50; B64C 3/14

(57) ABSTRACT

An aircraft airfoil having a wave assembly. The airfoil may include a leading edge, a trailing edge position opposite the leading edge, a pressure side extending between the leading edge and the trailing edge, and a suction side extending between the leading edge and the trailing edge. The suction side may be positioned opposite the pressure side. The airfoil may also include a wave assembly positioned on the suction side of the body. The wave assembly may include at least one leading edge flexural actuator positioned adjacent the leading edge of the body. The wave assembly may also include a flexible member having a first end portion affixed to the at least one leading edge flexural actuator, and a second end portion positioned opposite the first end portion, and adjacent the trailing edge of the body.

### BACKGROUND

The disclosure relates generally to airfoils for aircrafts, and more particularly, to wave assemblies included within airfoils, and methods of generating traveling waves on the surface of airfoils using the wave assemblies.

The development of wing slats/flaps, swept wings, and/or morphing wing designs are just some of the recent examples of aviation innovation that helps improve and/or optimize conventional aircraft travel. For example, each of the highlighted conventional designs have helped to improve and/or increase the lift of the aircraft; especially during takeoff or landing events. Increasing a lift coefficient for an aircraft may increase the aircraft's ability to take off at lower speed and/or more quickly. These improvements in turn can decrease fuel consumption and/or minimize the area needed (e.g., runway length) for an aircraft to take off and climb to cruising altitude.

However, conventional designs and innovation aviation still has not minimized the risk of separation and/or stall events from occurring during flight. Separation events occur when the air flowing over the wing separates or does not maintain contact with the wing. More specifically, the air flowing over the top side or surface of the wing (e.g., low pressure air) that contacts the leading edge of the wing may separate or distance itself from the surface of the wing as it flows from the leading edge to the trailing edge. This event reduces lift and increases drag in the wing/aircraft, and/or prevents the aircraft from being able to climb from the ground. Moreover, separation of the air from the wing may also result in a stall event. Stalls occur when the separated air flow reverses direction (e.g., trailing edge to leading edge) and/or flows against the rising pressure of the air flow flowing over the wing from the leading edge to the trailing edge. Stall events and/or the reverse flow of the air over the wing reduces the lift coefficient and increase the drag coefficient for the wing/aircraft, making it harder or impossible to launch the aircraft form the group. To prevent stall events, the separation of the air flowing over the wing must be minimized or eliminated.

### BRIEF DESCRIPTION

A first aspect of the disclosure provides an airfoil for an aircraft. The airfoil includes: a body including: a leading edge, a trailing edge position opposite the leading edge, a pressure side extending between the leading edge and the trailing edge, and a suction side extending between the leading edge and the trailing edge, the suction side positioned opposite the pressure side; and a wave assembly positioned on the suction side of the body, the wave assembly including: at least one leading edge flexural actuator positioned adjacent the leading edge of the body, and a flexible member including a first end portion affixed to the at least one leading edge flexural actuator, and a second end portion positioned opposite the first end portion, and adjacent the trailing edge of the body.

A second aspect of the disclosure provides a system used in an airfoil of an aircraft. The system includes: a wave assembly positioned on a suction side of the airfoil, the suction side extending between a leading edge and a trailing edge of the airfoil, wherein the wave assembly includes: at least one leading edge flexural actuator positioned adjacent the leading edge of the airfoil, and a flexible member including a first end portion affixed to the at least one leading edge flexural actuator, and a second end portion positioned opposite the first end portion, and adjacent the trailing edge of the airfoil; and a control system in communication with the wave assembly, the control system configured to: actuate the at least one leading edge flexural actuator to generate a traveling wave through the flexible member, the traveling wave including a predetermined frequency and a predetermined amplitude based on operational characteristics of the aircraft.

A third aspect of the disclosure provides a method including: determining operational characteristics of an aircraft, the aircraft including an airfoil having: a wave assembly positioned on a suction side of the airfoil, the suction side extending between a leading edge and a trailing edge of the airfoil, wherein the wave assembly includes: at least one leading edge flexural actuator positioned adjacent the leading edge of the airfoil, and a flexible member including a first end portion affixed to the at least one leading edge flexural actuator, and a second end portion positioned opposite the first end portion, and adjacent the trailing edge of the airfoil; and actuating the at least one leading edge flexural actuator to generate a traveling wave through the flexible member, the traveling wave including a predetermined frequency and a predetermined amplitude based on operational characteristics of the aircraft.

A fourth aspect of the disclosure provides a component including: a body having: a first edge, a second edge positioned opposite the first edge, a first side extending between the first edge and the second edge, and a second side extending between the first edge and the second edge, the second side positioned opposite the first side; and a wave assembly positioned on the second side of the body, the wave assembly including: at least one first end flexural actuator positioned adjacent the first edge of the body, and a flexible member including a first end portion affixed to the at least one first end flexural actuator, and a second end portion positioned opposite the first end portion, and adjacent the second edge of the body.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a top view of an aircraft including airfoils, according to embodiments of the disclosure.

FIG. 2 shows an enlarged top view of the aircraft of FIG. 1 including an airfoil having a wave assembly, according to embodiments of the disclosure.

FIG. 3 shows a side cross-sectional view of the airfoil of the aircraft shown in FIG. 2 taken along line CS-CS, according to embodiments of the disclosure.

FIGS. 4A-4C shows a side cross-sectional view of the airfoil during various stages of operation of the wave assembly, according to embodiments of the disclosure.

FIG. 5 shows an enlarged top view of an aircraft including an airfoil having a wave assembly, according to additional embodiments of the disclosure.

FIG. 6 shows an enlarged, cross-sectional side view of the component of FIG. 5, according to embodiments of the disclosure.

FIG. 7 shows an enlarged, cross-sectional side view of the component of FIG. 5, according to additional embodiments of the disclosure.

FIG. 8 shows an enlarged, cross-sectional side view of the component of FIG. 5, according to another embodiment of the disclosure.

FIG. 9 shows an enlarged top view of an aircraft including an airfoil having a wave assembly, according to further embodiments of the disclosure.

FIG. 10 shows an enlarged top view of an aircraft including an airfoil having a wave assembly, according to another embodiment of the disclosure.

FIG. 11 shows an enlarged top view of an aircraft including an airfoil having two wave assemblies, according to embodiments of the disclosure.

FIGS. 12A-12C show a side cross-sectional views of the airfoil of the aircraft shown in FIG. 2 taken along line CS-CS, according to further embodiments of the disclosure.

FIGS. 13A-13D show side views of various flexible members of a wave assembly for an airfoil, according to embodiments of the disclosure.

FIG. 14 shows a flowchart illustrating a process for generating traveling waves using a wave assembly positioned on an airfoil, according to embodiments of the disclosure.

FIG. 15 shows a perspective view of a turbine blade including a wave assembly, according to embodiments of disclosure.

FIG. 16 shows a top, cross-sectional view of the turbine blade shown in FIG. 15 taken along line CS-CS, according to further embodiments of the disclosure.

FIG. 17 shows a perspective view of a stator vane including a wave assembly, according to embodiments of disclosure.

FIG. 18 shows a top, cross-sectional view of the stator vane shown in FIG. 17 taken along line CS-CS, according to further embodiments of the disclosure.

FIG. 19 shows a top view of a component including a system having a wave assembly and a control system, according to further embodiments of the disclosure.

FIG. 20 shows a side cross-sectional view of the component of FIG. 19 taken along line CS-CS, according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

As an initial matter, in order to clearly describe the current disclosure it will become necessary to select certain terminology when referring to and describing relevant machine components within the disclosure. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

As indicated above, the disclosure relates generally to airfoils for aircrafts, and more particularly, to wave assemblies included within airfoils, and methods of generating traveling waves on the surface of airfoils using the wave assemblies.

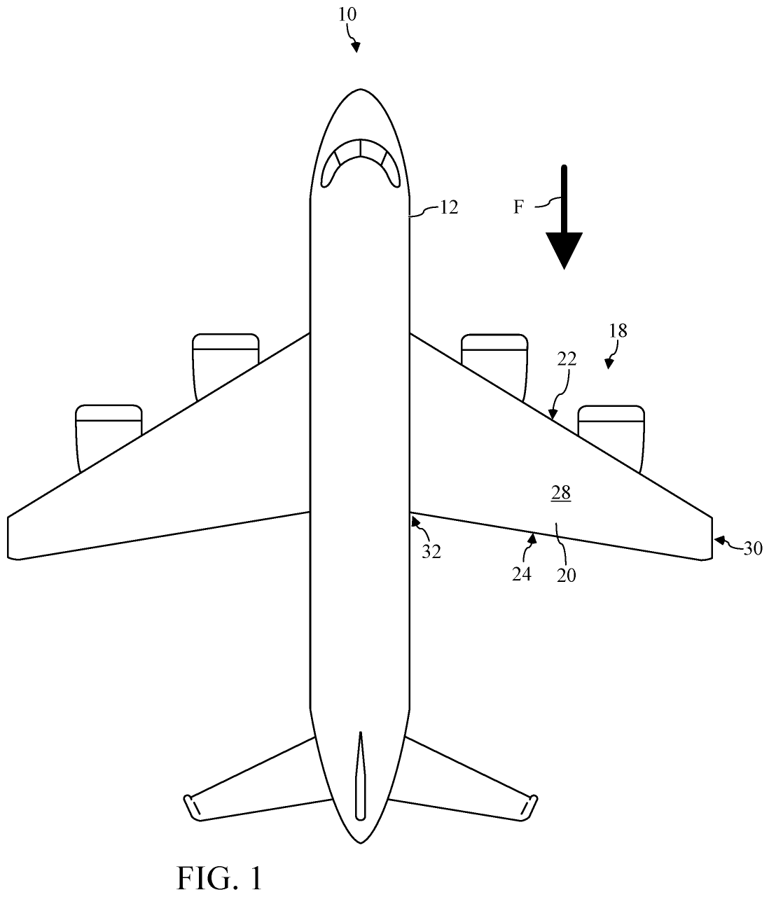

These and other embodiments are discussed below with reference to FIGS. 1-20. However, those skilled in the art will readily appreciate that the detailed description given herein with respect to these Figures is for explanatory purposes only and should not be construed as limiting.

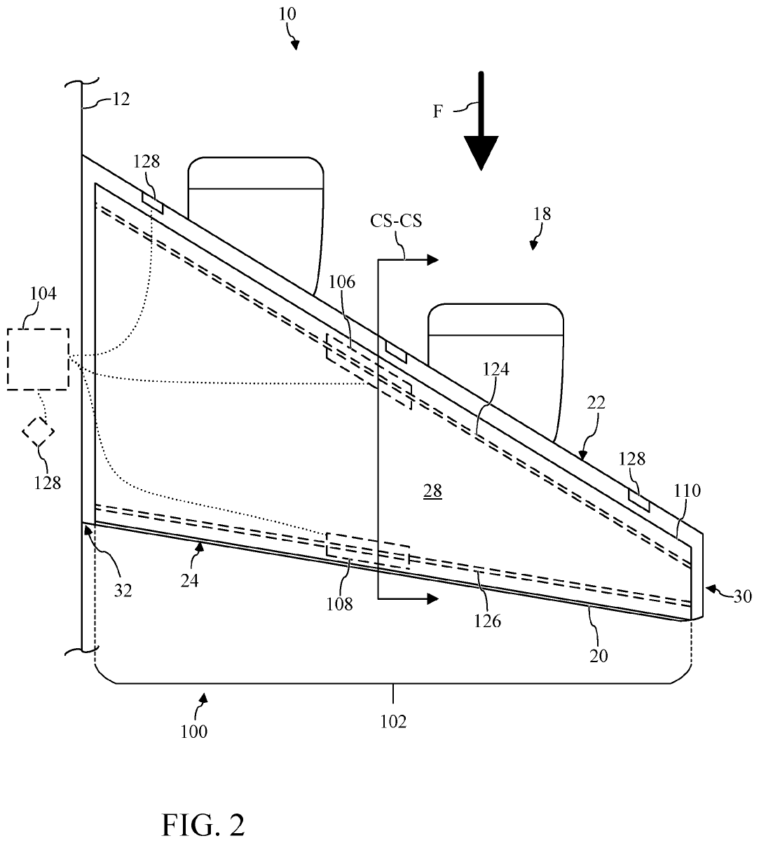

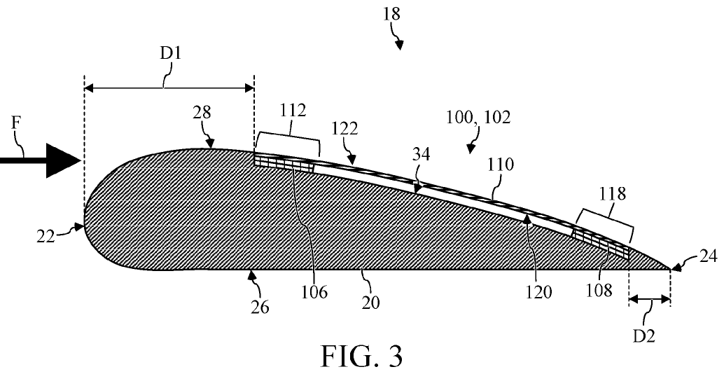

FIGS. 1-3 show various views of an aircraft having a system that includes a wave assembly. Specifically, FIG. 1 shows a top view of an entire aircraft, FIG. 2 shows an enlarged, top view an airfoil for the aircraft of FIG. 1, and FIG. 3 shows a cross-sectional side view of the airfoil for the aircraft.

Aircraft 10 shown in FIG. 1 may include any suitable vehicle that is capable of flying by gaining support from fluid (e.g., air). For example, aircraft 10 may be formed as any suitable aerodyne-based vehicle, such as a fixed-wing or airplane. Aircraft 10 may include a cabin or cargo portion 12 (hereafter, “cabin portion 12”) and a plurality of airfoils 18 coupled thereto. That is, aircraft 10 may include a plurality of airfoils 18 coupled to cabin portion 12. In non-limiting examples, airfoils 18 may be substantially fixed, variable geometry, variable-sweep (e.g., swing wing), or any other suitable airfoil configuration used on aircraft 10. Additionally, and as shown in FIG. 1, airfoil 18 of aircraft 10 may be formed and/or configured as a swept wing configuration. However, it is understood that airfoil 18 may be formed to include any suitable configuration and/or geometry, for example, straight wing, delta wing, and/or tapered wing. For example, in the non-limiting examples shown and as discussed herein, airfoil 18 may be formed as a morphing wing that is configured to (continuously) alter the geometry, tilt, angle of rotation/attack, and/or pitch of the airfoil during operation.

As shown in FIGS. 1-3, airfoil 18 may include various portions, sections, surfaces, and/or edges. For example, each airfoil 18 may include a body 20 including a leading edge 22, and a trailing edge 24 positioned opposite leading edge 22. Additionally, body 20 of airfoil 18 may include a pressure or high pressure side 26 (hereafter, “pressure side 26”) (see, FIG. 3) extending between leading edge 22 and trailing edge 24, as well as a suction or low pressure side 28 (hereafter, “suction side 28”) extending between leading edge 22 and trailing edge 24. Suction side 28 may be positioned and/or formed opposite pressure side 26. During operation (e.g., flight), fluid (e.g., air) may flow over airfoil 18/body 20 in a direction (F) and may initially flow over or contact leading edge 22. The fluid may continue to flow over pressure side 26 and suction side 28, respectfully, before being discharged from and/or off trailing edge 24. As discussed herein, the flow of the fluid over airfoil 18/body 20, as well as the flow of the fluid from pressure side 26 to suction side 28 (e.g., high pressure to low pressure) creates lift of airfoil 18, and ultimately allows aircraft 10 to leave the ground.

Airfoil 18 and/or body 20 of airfoil 18 may also include a tip portion 30 positioned and/or formed distal to cabin 12 of aircraft 10. In the non-limiting example shown in FIGS. 1 and 2, tip portion 30 of swept wing aircraft 10 may be the widest portion of aircraft 10, and may form a narrowed end of airfoil 18. Airfoil 18/body 20 may also include root portion 32. Root portion 32 may be formed and/or positioned opposite tip portion 30. Root portion 32 may extend between leading edge 22 and trailing edge 24 of airfoil 18/body 20. Additionally, root portion 32 may be coupled or affixed directly to, and therefore may couple airfoil 18 to, cabin 12 of aircraft 10. As such, root portion 32 may be positioned and/or formed proximal cabin 12.

Aircraft 10 may also include a system 100 including a wave assembly 102 and a control system 104. More specifically, and as shown in FIGS. 2 and 3, aircraft 10 may include system 100, such that airfoils 18 of aircraft 10 each include wave assembly 102 positioned thereon, and control system 104 positioned within aircraft 10 and in electronic communication each wave assembly 102 of system 100. In a non-limiting example, aircraft 10 may be initially manufactured, built, fabricated, and/or designed to include system 100 and its various portions (e.g., wave assembly 102, control system 104). In another non-limiting example, aircraft 10 may be modified, fitted, and/or may have system 100 installed or implemented post-manufacturing. As such, system 100 and its various portions discussed herein may be included within aircraft 10 at an initial build or manufacturing stage, or alternatively may be installed or retrofitted into an existing (e.g., previously built) aircraft 10.

Wave assembly 102 of system 100 may be formed and/or positioned on and/or adjacent suction side 28 of airfoil 18/body 20. Additionally, and as shown in FIGS. 2 and 3, wave assembly 102 of system 100 may be formed and/or position substantially between leading edge 22 and trailing edge 24, as well as tip portion 30 and root portion 32 of airfoil 18/body 20, respectively. Wave assembly 102 of system 100 may include at least one leading edge (LE) flexural actuator 106 (shown in phantom in FIG. 2) (hereafter, “LE actuator(s) 106”). LE actuator(s) 106 may be formed and/or positioned adjacent to and downstream of leading edge 22 of airfoil 18/body 20. In a non-limiting example, LE flexural actuator 106 may be formed and/or positioned on/within suction side 28 of airfoil 18, adjacent from, downstream of, and at a predetermined distance (D1) from leading edge 22 of airfoil 18 as well. The predetermined distance (D1) may be based on, at least in part, a plurality of airfoil 18 characteristics and/or operational characteristics of aircraft 10. For example, airfoil characteristics may include the size, geometry, angular movement (if any) of airfoil 18/body 20, while the operational characteristics of aircraft may include a maximum/average velocity of travel, a maximum/average altitude of travel, a maximum/average atmospheric pressure for fluid surrounding aircraft 10 during operation and the like.

Additionally, LE actuator(s) 106 may be coupled, secured, and/or affixed to airfoil 18/body 20 of aircraft. In a non-limiting example shown in FIG. 3, body 20 of airfoil 18 may include a recess 34 formed at least partially through and in at least a portion of suction side 28. Recess 34 may be formed at least partially through suction side 28 between leading edge 22 and trailing edge 24, respectively. Recess 34 formed in airfoil 18/body 20 may receive LE actuator(s) 106 and/or LE actuator(s) 106 may be seated in, positioned within, and/or affixed to recess 34 of airfoil 18. In the non-limiting example shown in FIG. 3, LE actuator(s) 106 may be positioned entirely within recess 34 such that in an “off” or inoperable state (e.g., FIG. 3), no portion of LE actuator(s) 106 may extend above and/or beyond suction side 28 of airfoil 18/body 20. LE actuator(s) 106 may be coupled to, secured within, and/or affixed to airfoil 18/body 20, and more specifically recess 34, using any suitable coupling component and/or technique. For example, LE actuator(s) 106 may be coupled or affixed within recess 34 using an adhesive, form a weld or braze, mechanical fastener(s) (e.g., rivets, bolts, screws, etc.), and the like.

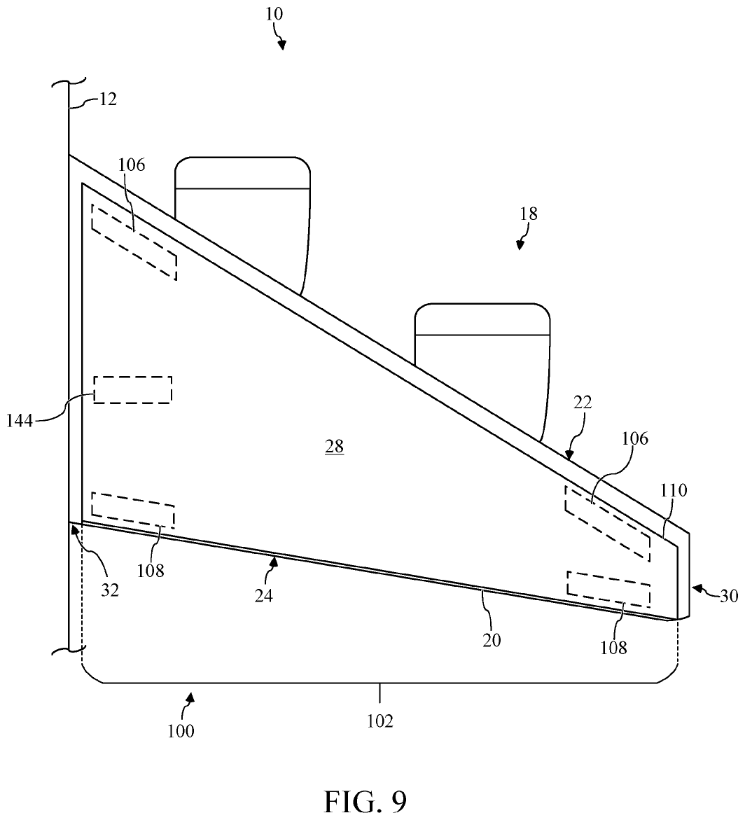

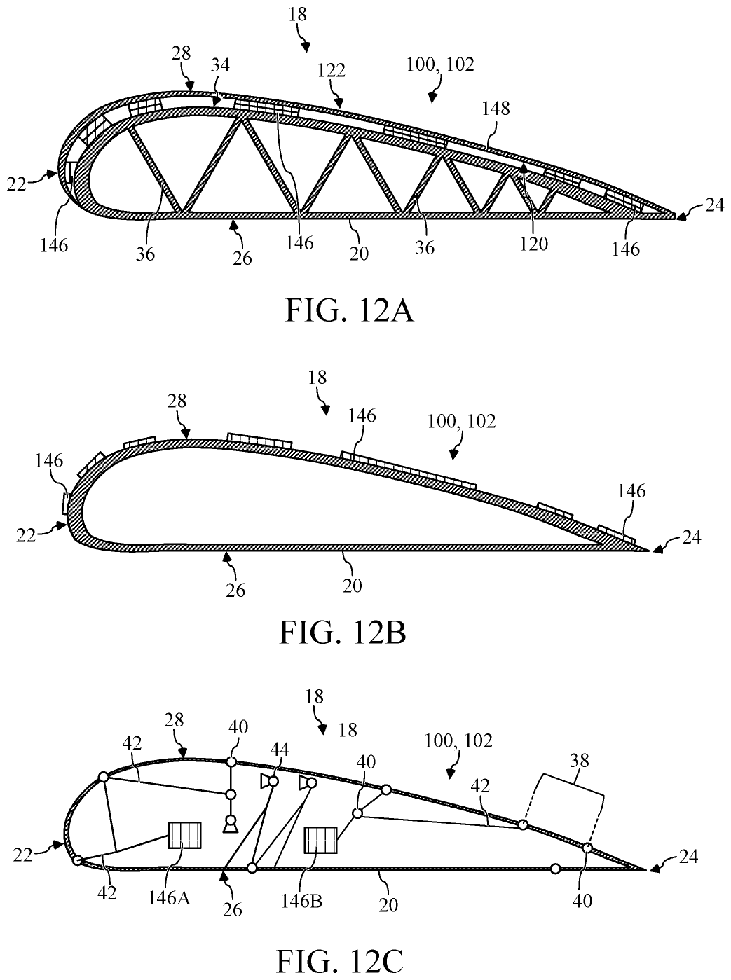

LE actuator(s) 106 of wave assembly 102 may be formed as any suitable actuator or actuation device that may form or be configured to form a traveling wave in a flexible member of wave assembly 102, as discussed herein. In non-limiting examples, LE actuator(s) 106 may be formed as a flexural actuator, flexure-guided actuator, and/or flextensional actuators. The flexural actuator forming LE actuator(s) 106 may be formed, for example, as a piezoelectric or Piezo flexure actuator. As discussed herein, flexural actuator(s) may be actuated by supplying a voltage thereto, and in turn may move, displace, and/or vibrate a flexible member of the wave assembly 102 to form a traveling wave on airfoil 18 during operation of aircraft 10. In other non-limiting examples, LE actuator(s) 106 may be formed from any other suitable actuator or actuating device that may be configured to form a traveling wave on airfoil 18 as discussed herein. Suitable actuators may include, but are not limited to, mechanical actuators, pneumatic actuators, hydraulic actuators, electric actuators, and/or spring actuators. In another non-limiting example where airfoil 18 is formed or configured as a morphing wing, LE actuator(s) 106 of wave assembly 102 may be the same actuators that may adjust the position, tilt, angle of rotation/attack, and/or geometry of morphing wing airfoil 18 (see, FIGS. 12A-12C). Additionally, although a single LE actuator(s) 106 is shown in FIGS. 2 and 3, it is understood that wave assembly 102 of system 100 may include more LE actuator(s) 106 (see, FIGS. 9-11).

Wave assembly 102 of system 100 may also include at least one trailing edge (TE) flexural actuator 108 (shown in phantom in FIG. 2) (hereafter, “TE actuator(s) 108”). TE actuator(s) 108 may be substantially similar to LE actuator(s) 106, as discussed herein. For example, TE actuator(s) 108 may be formed and/or positioned adjacent to and upstream of trailing edge 24 of airfoil 18/body 20. In a non-limiting example, TE actuator 108 may be formed and/or positioned on/within suction side 28 of airfoil 18, adjacent from, upstream of, and at a predetermined distance (D2) from trailing edge 24 of airfoil 18 as well. The predetermined distance (D2) may be based on, at least in part, a plurality of airfoil 18 characteristics and/or operational characteristics of aircraft 10. For example, airfoil characteristics may include the size, geometry, angular movement (if any) of airfoil 18/body 20, while the operational characteristics of aircraft may include a maximum/average velocity of travel, a maximum/average altitude of travel, a maximum/average atmospheric pressure for fluid surrounding aircraft 10 during operation and the like.

Additionally, TE actuator(s) 108 may be coupled, secured, and/or affixed to airfoil 18/body 20 of aircraft. In a non-limiting example shown in FIG. 3, and similar to LE actuator(s) 106, TE actuator(s) 108 may be seated in, positioned within, and/or affixed to recess 34 of airfoil 18, substantially adjacent trailing edge 24. In the non-limiting example shown in FIG. 3, TE actuator(s) 108 may be positioned entirely within recess 34 such that in an “off” or inoperable state (e.g., FIG. 3), no portion of TE actuator(s) 108 may extend above and/or beyond suction side 28 of airfoil 18/body 20. TE actuator(s) 108 may be coupled to, secured within, and/or affixed to airfoil 18/body 20, and more specifically recess 34, using any suitable coupling component and/or technique. For example, TE actuator(s) 108 may be coupled or affixed within recess 34 using an adhesive, form a weld or braze, mechanical fastener(s) (e.g., rivets, bolts, screws, etc.), and the like.

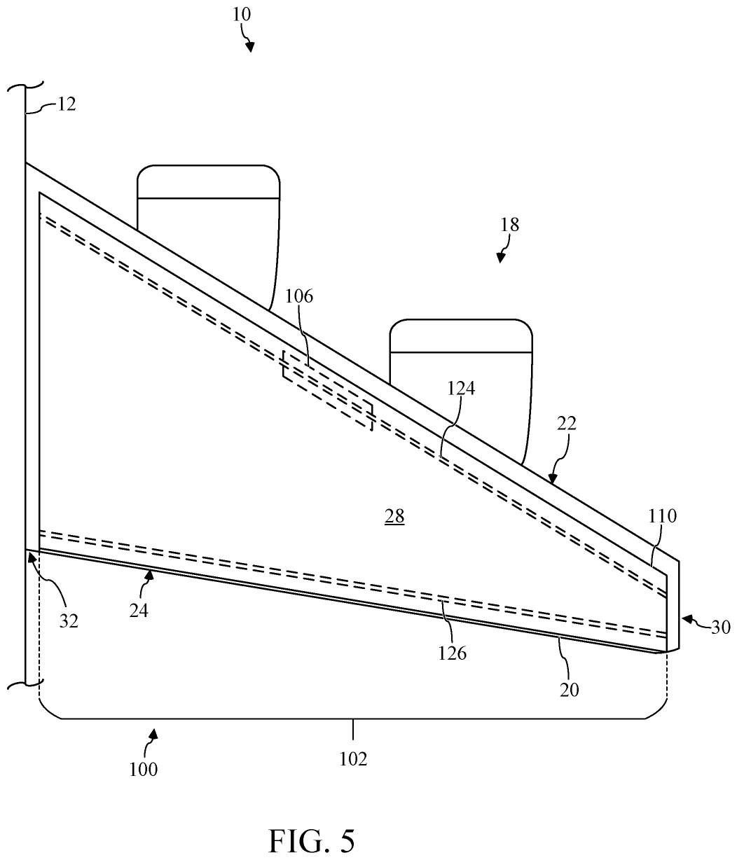

Also similar to LE actuator(s) 106, TE actuator(s) 108 of wave assembly 102 may be formed as any suitable actuator or actuation device that may form or be configured to form a traveling wave in a flexible member of wave assembly 102, as discussed herein. In non-limiting examples, TE actuator(s) 108 may be formed as a flexural actuator, flexure-guided actuator, and/or flextensional actuators. The flexural actuator forming TE actuator(s) 108 may be formed, for example, as a piezoelectric or Piezo flexure actuator. As discussed herein, flexural actuator(s) may be actuated by supplying a voltage thereto, and in turn may move, displace, and/or vibrate a flexible member of the wave assembly 102 to form a traveling wave on airfoil 18 during operation of aircraft 10. In other non-limiting examples, TE actuator(s) 108 may be formed from any other suitable actuator or actuating device that may be configured to form a traveling wave on airfoil 18 as discussed herein. Suitable actuators may include, but are not limited to, mechanical actuators, pneumatic actuators, hydraulic actuators, electric actuators, and/or spring actuators. Similar to LE actuator(s) 106, and as discussed herein, TE actuator(s) 108 of wave assembly 102 may be the same actuators that may adjust the position, tilt, angle of rotation/attack, and/or geometry of a morphing wing airfoil 18 (see, FIGS. 12A-12C). Additionally, although a single TE actuator(s) 108 is shown in FIGS. 2 and 3, it is understood that wave assembly 102 of system 100 may include no TE actuator (see, FIG. 5) or more TE actuator(s) 108 (see, FIGS. 9-11).

As shown in FIGS. 2 and 3, wave assembly 102 of system 100 may also include at least one flexible member 110. Flexible member 110 of wave assembly 102 may be actuated and/or displaced by LE actuator(s) 106/TE actuator(s) 108 to generate a traveling wave on or in airfoil 18 during operation, as discussed herein. In a non-limiting example shown in FIG. 3, flexible member 110 may include a first end portion 112 positioned adjacent to and downstream of leading edge 22 of airfoil 18. As shown in FIG. 3, first end portion 112 of flexible member 110 may be coupled, secured, and/or affixed to LE actuator(s) 106 of wave assembly 102. First end portion 112 of flexible member 110 may be coupled, secured, and/or affixed to LE actuator(s) 106 using any suitable coupling technique and/or component. For example, first end portion 112 of flexible member 110 may be adhered directly to LE actuator(s) 106. A first end of flexible member 110 included in first end portion 112 may be coupled, secured, and/or affixed to LE actuator(s) 106, or alternatively, may be coupled, secured, and/or affixed to a portion of airfoil 18/body 20—for example a side wall of recess 34.

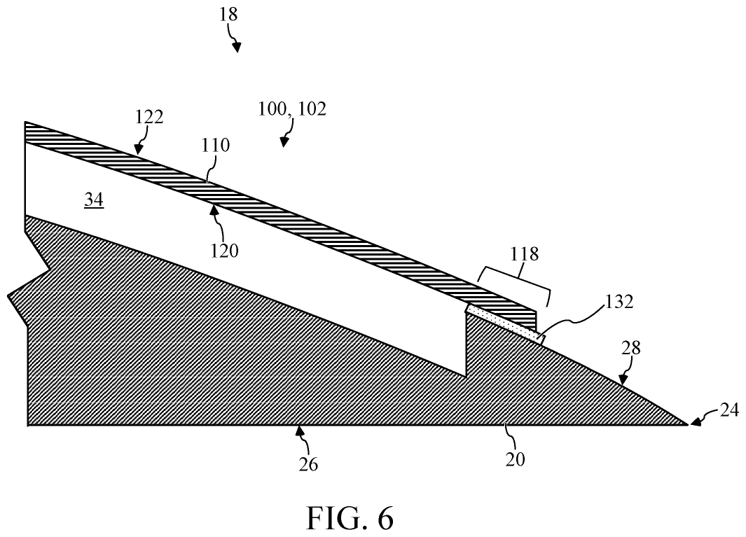

Flexible member 110 of wave assembly 102 may also include a second end portion 118 positioned and/or formed opposite first end portion 112. Second end portion 118 may also be positioned and/or formed adjacent to and upstream of trailing edge 24 of airfoil 18. As shown in FIG. 3, second end portion 118 of flexible member 110 may be coupled, secured, and/or affixed to TE actuator(s) 108 of wave assembly 102. Second end portion 118 of flexible member 110 may be coupled, secured, and/or affixed to TE actuator(s) 108 using any suitable coupling technique and/or component. For example, second end portion 118 of flexible member 110 may be adhered directly to TE actuator(s) 108. In other non-limiting examples, second end portion 118 may be coupled, secured, and/or affixed to airfoil 18/body 20 (see, FIGS. 6-8). A second end of flexible member 110 included in second end portion 118 may also be coupled, secured, and/or affixed to TE actuator(s) 108, or alternatively, may be coupled, secured, and/or affixed to a portion of airfoil 18/body 20 (e.g., side wall of recess 34).

Flexible member 110 may also include a first surface 120 extending between first end portion 112 and second end portion 118. In the non-limiting example shown in FIG. 3, first surface 120 of flexible member 110 may be affixed to and/or directly contact LE actuator(s) 106 and TE actuator(s) 108 of wave assembly 102. Additionally, first surface 120 may be positioned within and/or may face recess 34 formed in airfoil 18/body 20, and may not be exposed to ambient fluid flowing over airfoil 18 during operation of aircraft 10 including wave assembly 102.

Flexible member 110 may also include a second surface 122. Similar to first surface 120, second surface may extend between first end portion 112 and second end portion 118 of flexible member 110, opposite first surface 120. Second surface 122 of flexible member 110 may be exposed on airfoil 18, and/or may be positioned opposite a recess 34 of airfoil 18. As such in the non-limiting example, fluid flowing over airfoil 18 during operation of aircraft 10 may flow directly over and/or may contact second surface 122 of flexible member 110. As shown in FIG. 3, at least a portion of second surface 122 of flexible member 110 formed adjacent first end portion 112 may be in (planar) alignment with suction side 28 of airfoil 18/body 20. That is, at least a portion of second surface 122 may be substantially aligned, with, co-planar, and/or level with the surface of suction side 28 of airfoil 18 positioned upstream of flexible member 110, such that second surface 122 is even and/or flush with the surface of suction side 28 while wave assembly is inoperable and/or flexible member 110 is in an unexcited-state.

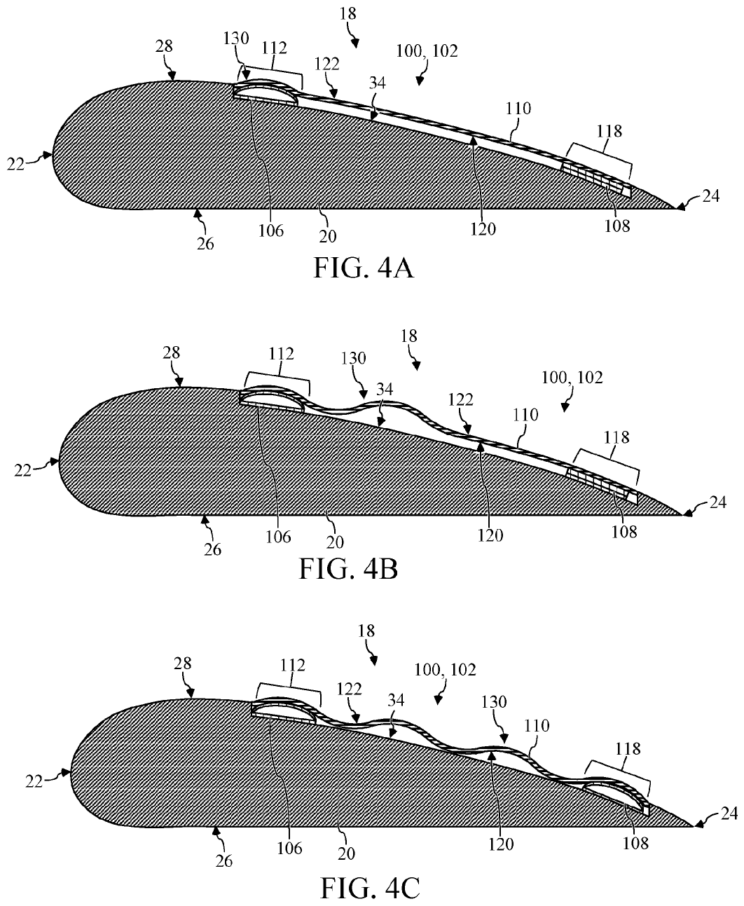

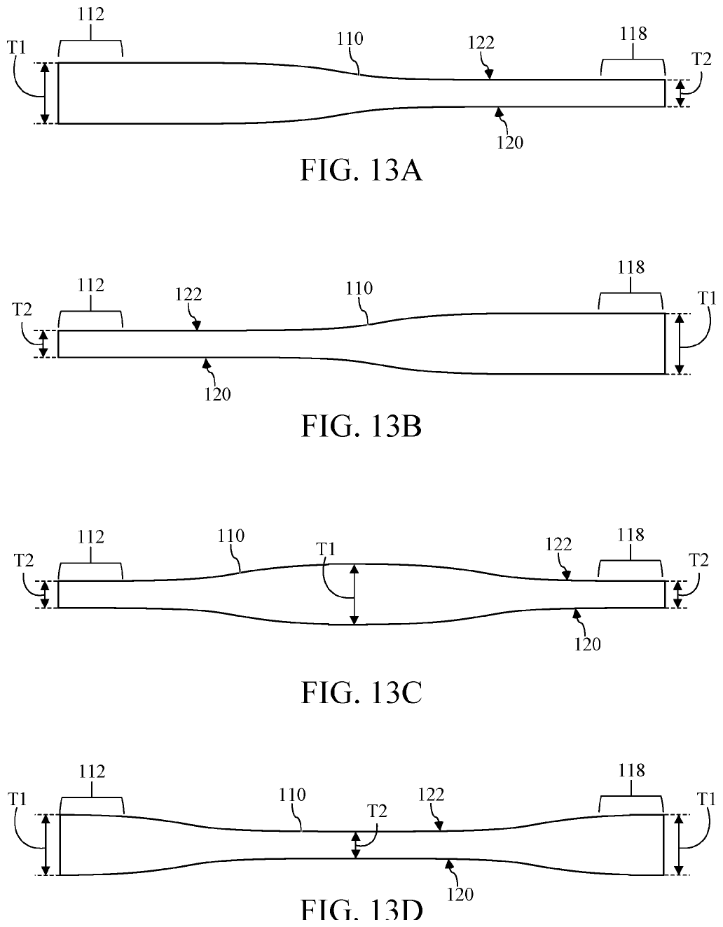

As shown in FIG. 3, flexible member 110 may also be substantially positioned and/or housed within recess 34 formed in airfoil 18. Additionally, and as discussed herein, a space defined by recess 34, and formed between LE actuator(s) 106 and TE actuator(s) 108) may receive moving, bending, oscillating, and/or excited flexible member 110 when a traveling wave is formed thereon (see, FIG. 4C). Flexible member 110 may be formed from any suitable flexible material and/or component that may also withstand the stresses and/or strains imparted on the member during operation or flight of aircraft 10. In non-limiting examples, flexible member 110 may for formed from metal or metal-alloy material. In other non-limiting examples, flexible member 110 may for formed from polymer, graphene, carbon-fiber, shape memory alloy, or any other suitable material having similar elastic and strength characteristics or properties. In the non-limiting example, flexible member 110 is shown to include a uniform thickness. However, it is understood that flexible member may have a varying or variable thickness extending from first end portion 112 to second end portion 118 (see, FIGS. 13A-13D). The thickness of flexible member 110 may be dependent upon, at least in part, the material used to form flexible member 110, the size or dimension of flexible member 110, the size and/or shape of airfoil 18 of aircraft 10 using flexible member 110, and/or flight or operational characteristics of aircraft 10. In a non-limiting example, flexible member 110 may have a thickness within a range of approximately 0.001 inches (in) to 0.1 in.

Furthermore, although shown as substantially spanning over the entire length between tip portion 30 and root portion 32 of airfoil 18, it is understood that the width (e.g., dimension extending substantially parallel to first end portion 112) of flexible member 110 may be larger or smaller than that shown in the figures. In a non-limiting example where flexible member 110 of wave assembly 102 does not span over substantially the entire length of airfoil 18, flexible member 110 may be centrally located on airfoil 18, or alternatively may be positioned adjacent top portion 30 or root portion 32.

Returning briefly to FIG. 2, wave assembly 102 may also include at least one stiffening component. In the non-limiting example, wave assembly 102 may include a first stiffening component 124 (shown in phantom) and a second, distinct stiffening component 126 (shown in phantom). First stiffening component 124 may be positioned adjacent leading edge 22 of airfoil 18, and/or may be positioned adjacent to and/or substantially aligned with first end portion 112 of flexible member 110. Additionally, first stiffening component 124 may be coupled, secured, and/or affixed to flexible member 110, and more specifically first surface 120 of flexible member 110. In another non-limiting example, first stiffening component 124 may be formed integrally within (e.g., cast within) flexible member 110. As shown in FIG. 2, first stiffening component 124 may also extend over flexible member 110 substantially between tip portion 30 and root portion 32 of airfoil 18.

Second stiffening component 126 may be positioned adjacent to and/or substantially aligned with second end portion 118 of flexible member 110. Similar to first stiffening component 124, second stiffening component 124 may also be coupled, secured, and/or affixed to flexible member 110, and more specifically first surface 120 of flexible member 110. In another non-limiting example, second stiffening component 126 may be formed integrally within (e.g., cast within) flexible member 110. In the non-limiting example, second stiffening component 126 may also extend over flexible member 110 substantially between tip portion 30 and root portion 32 of airfoil 18, adjacent to and upstream of trailing edge 24.

Stiffening components 124, 126 may be formed from any light-weight material that may be substantially rigid and/or structurally supportive to flexible member 110. For example, stiffening components 124, 126 of wave assembly 102 may be formed from substantially rigid metal or metal alloys. Stiffening components 124, 126 may be included within wave assembly 102 and/or coupled to flexible member 110 to prevent bend, sag, and/or droop in flexible member 110 during operation (e.g., traveling wave). Specifically, stiffening components 124, 126 may prevent undesirable bend, sag, or droop near portions of flexible member 110 positioned adjacent tip portion 30, root portion 32, and/or portions of flexible member 110 positioned distal to actuator(s) 106, 108. Additionally or alternatively, the inclusion of stiffening components 124, 126 and preventing the bend in portions of flexible member 110 may also ensure traveling wave moving across flexible member 110 is uniform from first end portion 112 to second end portion 118, and/or does not vary or become unstable between tip portion 30 and root portion 32. This may be especially beneficial where only one actuator in total (e.g., LE actuator 106) or two total (e.g., LE actuator 106, TE actuator 108) are used to form the traveling wave in flexible member 110. Stiffening components 124, 126 are omitted from FIG. 3 for the sake of clarity in the figures.

System 100 may also include control system 104. System 100 may also include a control system 104. Control system 104 may be a stand-alone system, or alternatively may be a portion and/or included in a larger computing device (not shown) of system 100. For example, and as shown in FIG. 2, control system 104 may be positioned within cabin 12 of aircraft 10 as its own system. Alternatively, control system 104 may be part of the overall control/computing system that is used in the operation or flight of aircraft 10. As discussed herein, control system 104 may be configured to control wave assembly 102, and more specifically control the operation of the various components or portions of wave assembly 102 to generate a traveling wave in flexible member 110 during operation of aircraft 10. As shown in FIG. 2, control system 104 may be in electronic communication with and/or communicatively coupled to various devices, apparatuses, and/or portions of system 100. In non-limiting examples, control system 104 be hard-wired and/or wirelessly connected to and/or in communication with system 100, and its various components via any suitable electronic and/or mechanical communication component or technique. For example, control system 104 may be in electronic communication with LE actuator(s) 106 and TE actuator(s) 108. Control system 104 may be in communication with actuator(s) 106, 108 to control the movement, actuation, and/or operation of actuator(s) 106, 108 during the traveling wave generation process discussed herein. Additionally, and as discussed herein, control system 104 may also receive, process, and/or analyze inputs from various devices, portions, and/or sensors within aircraft 10 and/or system 100 to perform and/or optimize the generation of a traveling wave on flexible member 110.

System 100 may also include at least one sensor 128. Sensor(s) 128 may be positioned within system 100 to monitor, determine, and/or detect various operational and/or flight characteristics/parameters for aircraft 10. In the non-limiting example shown in FIG. 2, sensor(s) 128 may be formed integral with and/or may be positioned on leading edge 22 of airfoil 18. Additionally, sensor(s) 128 may be positioned throughout aircraft 12 to detect operational and/or flight characteristics/parameters for aircraft 10. Furthermore, control system 104 may include and/or may be in electronic communication with a system for controlling and monitoring the operation of aircraft 10, which includes measured, determined, obtained, and/or calculated operational and/or flight characteristics/parameters for aircraft 10 during operation. The various operational and/or flight characteristics/parameters for aircraft 10 may, at least in part, influence, effect, and/or impact the operation of wave assembly 102, and more specifically the traveling wave generated in flexible member 110. The operational and/or flight characteristics/parameters for aircraft 10 may include, but are not limited to, a velocity of aircraft 10, an altitude of aircraft 10, flight status of aircraft 10 (e.g., takeoff, landing, cruising-at-altitude), an atmospheric pressure of the ambient fluid surrounding aircraft 10, size/dimensions of airfoil 18 for aircraft 10, geometry of airfoil 18 for aircraft 10, movement-capabilities (e.g., angle of rotation) of airfoil 18 for aircraft 10, and so on.

Control system 104 may be in electrical communication, mechanical communication, and electronically coupled with sensor(s) 128 positioned within system 100. As discussed herein, sensor(s) 128 in communication with control system 104 may be any suitable sensor or device configured to detect and/or determine data, information, and/or characteristics relating to the operational and/or flight characteristics/parameters for aircraft 10. Although four sensors 128 are shown, it is understood that system 100 may include more (or less) sensor(s) that may be configured to provide control system 104 with information or data relating to operational and/or flight characteristics/parameters for aircraft 10. As such, the number of sensors 128 shown in FIG. 2 is illustrative and non-limiting.

Turning to FIGS. 4A-4C, various side cross-sectional views airfoil 18 are shown during various stages of operation of wave assembly 102. More specifically, FIGS. 4A-4C show various stages of operation where wave assembly 102 generates a traveling wave in flexible member 110. It is understood that similarly numbered and/or named components may function in a substantially similar fashion. Redundant explanation of these components has been omitted for clarity.

FIG. 4A shows the initial or start-up stage of wave assembly 102 generating a traveling wave in flexible member 110. More specifically, FIG. 4A depicts a non-limiting example of the first actuation or movement of LE actuator(s) 106 to form or generate a traveling wave 130 in flexible member 110. In the non-limiting example, LE actuator(s) 106 may be actuated by control system 104 of system 100, and may in turn may move, displace, and/or vibrate flexible member 110. As shown in FIG. 4A the actuation of LE actuator(s) 106 may cause a portion (e.g., first end portion 112) to rise and/or begin to form a portion of a wave. Because of the actuation of LE actuator(s) 106 on flexible member 110, a peak or crest may be formed in first end portion 112 of flexible material 110.

FIG. 4B shows wave assembly 102 in airfoil 18 at a time after the initial or start-up stage in FIG. 4A. For example, FIG. 4B depicts a non-limiting example of the second, subsequent actuation or movement of LE actuator(s) 106 to continue generate traveling wave 130 in/through flexible member 110. As shown in FIG. 4B, the first wave (as generated in FIG. 4A) may travel through flexible member 110 and/or may travel from first end portion 112, where it originated, toward second end portion 118. Additionally, and as shown in FIG. 4B, the (second) actuation of LE actuator(s) 106 may cause a portion (e.g., first end portion 112) to rise and/or begin to form a (second) wave, or the traveling wave through flexible member 110. As shown in FIGS. 4B (and 4C) as traveling wave 130 forms in or moves through flexible member 110, a portion of flexible member 110 (e.g., a trough of the wave) may extend into recess 34 formed in body 20 of airfoil 18.

FIG. 4C shows wave assembly 102 at a later time in the process than that of FIG. 4B. In the non-limiting example, traveling wave 130 may be formed in the entire length of flexible member 110, such that waves exist and/or are aligned with both LE actuator(s) 106 and TE actuator (s) 108. Similar to LE actuator(s) 106, TE actuator(s) 108 is also shown as actuated within wave assembly 102 in FIG. 4C. However, TE actuator(s) 108 may not be actuated for the purpose of wave generation, but rather for the purpose of “catch,” receiving, and/or absorbing traveling wave 130 formed in or generated through flexible member 110. That is, TE actuator(s) 108 may be actuated within wave assembly 102 during the generation of traveling wave 130 through flexible member 110 to receive traveling wave 130 and/or dissipate traveling wave 130 at second end portion 118 of flexible member 110 to prevent reflection of traveling wave 130 through flexible member 110 (e.g., traveling wave 130 flowing from second end portion 118 to first end portion 112).

The actuation of LE actuator(s) 106 (and TE actuator(s) 108) may determine and/or define the amplitude (A), the frequency, the period, and/or the wavelength (λ) of each wave included in traveling wave 130. That is, the force, shape, duration of actuation, distance of actuation, and/or frequency of actuation by actuator(s) 106, 108 of wave assembly 102 may determine and/or define the amplitude (A) and wavelength (λ) for traveling wave 130 generated through flexible member 110, as discussed herein. Additionally, the amplitude (A) and wavelength (λ) may be predetermined, and may be based, at least in part, on the operational and/or flight characteristics/parameters for aircraft 10. For example, a velocity of aircraft 10, an altitude of aircraft 10, flight status of aircraft 10 (e.g., takeoff, landing, cruising-at-altitude), an atmospheric pressure of the ambient fluid surrounding aircraft 10, size/dimensions of airfoil 18 for aircraft 10, geometry of airfoil 18 for aircraft 10, and/or movement-capabilities (e.g., angle of rotation) of airfoil 18 for aircraft 10, may affect and/or determine the amplitude (A) and wavelength (λ) for traveling wave 130 generated through flexible member 110. As such, in a non-limiting example where it is determined or detected that the operational and/or flight characteristics/parameters for aircraft 10 change, the actuation properties or characteristics of actuator(s) 106, 108 may also change and/or be adjusted. Changing or adjusting the actuation of actuator(s) 106, 108 may in turn alter or change the amplitude (A) and wavelength (λ) for traveling wave 130 generated through flexible member 110.

As discussed herein, LE actuator(s) 106 (and TE actuator(s) 108) may be formed as flexural actuator(s) (e.g., piezoelectric). As shown in FIGS. 4A-4C, actuator(s) 106, 108 may also be actuated to form traveling wave 130 and may define the amplitude, wavelength, period, and/or frequency, which may be determined, at least in part, by the shape of the portion of actuator 106, 108 contacting flexible member 110. In one non-limiting example, actuator 106, 108 may be substantially flexible and/or may include a predetermined shape once actuated. In another example, actuators 106, 108 may include a predetermined, and fixed, predetermined geometry or shape that may remain or be permanent regardless of actuation or not.

The generation or formation of traveling wave 130 in flexible member 110 during operation of aircraft 10 may reduce, substantially eliminate, or control the separation of fluid from suction side 28 of airfoil 18. That is, by generating traveling wave 130 in flexible member 110 along suction side 28 of airfoil 18, fluid (e.g., air) flowing over suction side 28 may not separate, but rather may be agitated and/or pulled toward flexible member 110/suction side 28. Additionally, or alternatively, traveling wave 130 flowing through flexible member 110 for first end portion 112 to second end portion 118 (e.g., leading edge 22 to trailing edge 24) may help to push or flow the fluid along suction surface 28/flexible member 110 to trailing edge 24 without separating or reattaching the flow before the trailing edge 24. In reducing, eliminating, or controlling separation of the fluid flowing over airfoil 18, aircraft 10 may experience less stall events and/or the risk of stall events occurring on airfoil 18/aircraft 10 may be substantially reduced or eliminated.

FIG. 5 shows a top view of another non-limiting example of airfoil 18 of aircraft 10 including system 100 having wave assembly 102. Control system 104 and sensors 128 of system 100 are omitted from the figures for the sake of clarity. However, it is understood that airfoil 18 using system 100 also includes control system 104 as similarly discussed herein with respect to FIGS. 1-3.

In the non-limiting example shown in FIG. 5, wave assembly 102 may only include LE actuator 106. That is, wave assembly 102 of system 100 included or implemented within airfoil 18 of aircraft 10 may include only a single, LE actuator 106. In non-limiting example where wave assembly 102 only includes LE actuator 106, stiffening components 124, 126 may or may not also be included as well. That is, wave assembly 102 shown in FIG. 5 may include first stiffening component 124, and/or second component 126. Alternatively, wave assembly 102 may not include any stiffening components 124, 126 therein. LE actuator 106 and stiffening components 124, 126 may function and/or operate in a substantially similar manner as discussed herein with respect to FIGS. 1-3. As such, Redundant explanation of these components has been omitted for clarity.

As a result of only including single, LE actuator 106, second end portion 118 of flexible member 110 may be required to be substantially fixed and/or secured to or within airfoil 18. That is, second end portion 118 of flexible member 110 may connected, coupled, and/or fixed to airfoil 18. Connecting second end portion 118 to airfoil 18 may prevent flexible member 110 from become disconnected from airfoil 18, may allow traveling wave 130 to be formed in and/or through flexible member 110, as discussed herein, and/or may prevent fluid from undesirably flowing into recess 34 formed in airfoil 18.

Additionally, connecting second end portion 118 of flexible member 110 to airfoil 18 may aid in and/or ensure of dissipation of traveling wave 130 at second end portion 118 of flexible member 110 to prevent reflection of traveling wave 130 back through flexible member 110. FIGS. 6-8 show enlarged, cross-section views of trailing edge 24 of airfoil 18. In each non-limiting example shown in FIGS. 6-8, second end portion 118 of flexible member 110 may be connected, coupled, and/or affixed within airfoil 18.

Turning to FIG. 6, second end portion 118 of flexible member 110 may be connected to airfoil 18 using an adhesive 132. More specifically, second end portion 118 may be bonded and/or adhered to a portion of suction side 28 of airfoil 18 using adhesive 132. In the non-limiting example, second end portion 118 may be adhered to suction side 28 of airfoil 18 adjacent recess 34 formed therein. Adhesive 132 may connect or couple second end portion 118 to prevent second end portion 118 from becoming disengaged or disconnected from airfoil 18. However, adhesive 132 may be substantially flexible and/or may allow second end portion 118 to slightly move or deform during operation. By allowing second end portion 118 to move, second end portion 118 may receive traveling wave 130 and/or dissipate traveling wave 130 at second end portion 118 of flexible member 110 to prevent reflection of traveling wave 130 through flexible member 110. Adhesive 132 may be any suitable adhesive that may connect second end portion 118 to airfoil 18, while curing with elastic properties to allow flexible member 110 to move during operation.

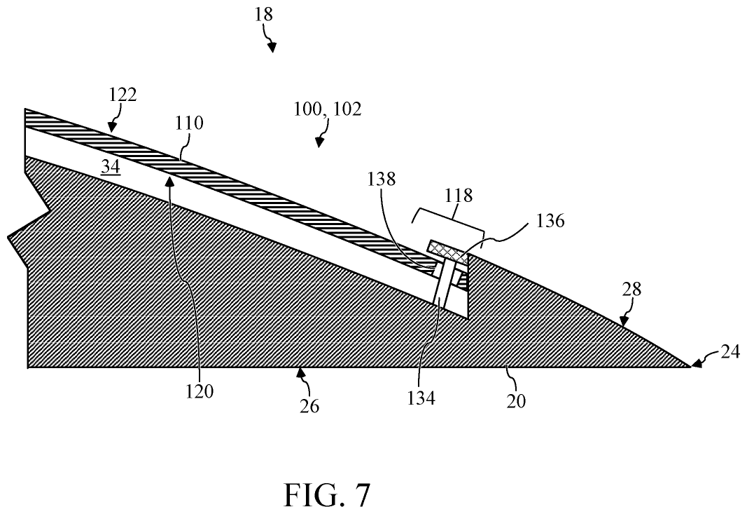

FIG. 7 shows another non-limiting example of connecting second end portion 118 to airfoil 18. In the non-limiting example, airfoil 18 may include a post or rod 134 (hereafter, “post 134”) and a support 136. In the non-limiting example, a hole 138 may be formed through second end portion 118 of flexible member 110. Post 134 may be positioned and/or extend through hole 138 in flexible member 110, and extend toward, contact, and/or be coupled to recess 34 formed in airfoil 18. As shown in FIG. 7, support 136 may also be coupled to recess 34, as well as be coupled or affixed to post 134, adjacent suction side 28. In the non-limiting example, second end portion 118 of flexible member 110 may be secured within recess 34 and/or may be prevented from being uncoupled or disconnected from airfoil 18 via post 134 and support 136. Additionally, by allowing second end portion 118 to move over post 134, between support 136 and recess 34, second end portion 118 may receive traveling wave 130 and/or dissipate traveling wave 130 at second end portion 118 of flexible member 110 to prevent reflection of traveling wave 130 through flexible member 110.

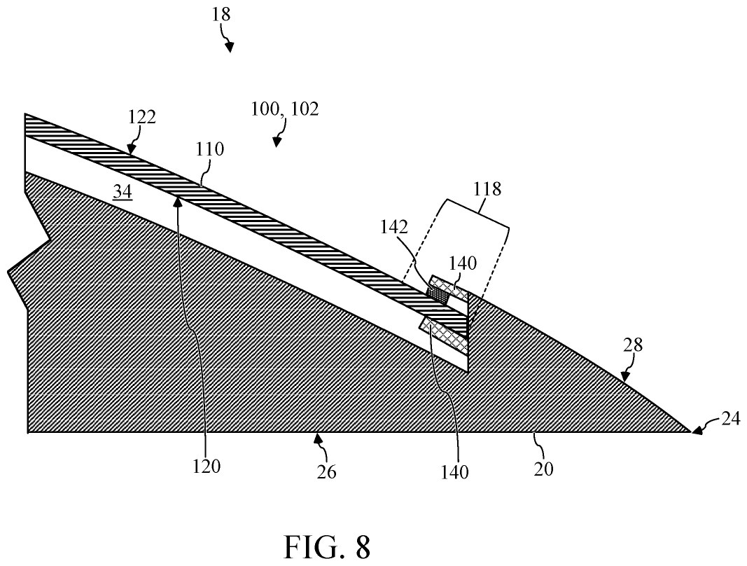

FIG. 8 shows another non-limiting example of connecting, coupling, and/or securing second end portion 118 of flexible member 110 within airfoil 18. In the non-limiting example, wave assembly 102 may also include a clamp 140 and at least one elastic feature 142 (e.g., rubber protrusion or stopper). Clamp 140 may be positioned within, coupled to, and/or extend from recess 34 of airfoil 18. Additionally, elastic feature 142 may be coupled to one, or both where two elastic features are included, of the portions of clamp 140, adjacent a space that may receive second end portion 118 of flexible member 110. In the non-limiting example, second end portion 118 of flexible member 110 may be positioned between and secured within airfoil 18 via claim 140 and elastic feature 142. In a non-limiting example, the elastic of flexible properties of elastic feature 142 may allow second end portion 118 of flexible member 110 to move, and ultimately receive traveling wave 130 and/or dissipate traveling wave 130 at second end portion 118 of flexible member 110 to prevent reflection of traveling wave 130 through flexible member 110. Additionally, or alternatively, clamp 140 may also be flexible and/or configured to move in order to allow second end portion 118 to move and dissipate traveling wave 130 at second end portion 118 of flexible member 110, as discussed herein.

Although a single post 134-support 136 is shown in FIG. 7, and a single clamp 140-rubber 142 is shown in FIG. 8, it is understood that wave assembly 102 may include a plurality of these features positioned within recess 34 and distributed within recess 34 between tip portion 30 and root portion 32.

FIGS. 9-11 including additional non-limiting examples of wave assembly 102 of system 100 included within airfoil 18 of aircraft 10. It is understood that similarly numbered and/or named components may function in a substantially similar fashion. Redundant explanation of these components has been omitted for clarity.

Turning to FIG. 9, wave assembly 102 of system 100 may include a plurality of actuators 106, 108 included therein. More specifically, wave assembly 102 may include two distinct LE actuators 106, as well as two distinct TE actuators 108. In the non-limiting example, one LE actuator 106 may be positioned adjacent leading edge 22 and tip portion 30, while another LE actuator 106 may be positioned adjacent leading edge 22 and root portion 32. Similarly, one TE actuator 108 may be positioned adjacent trailing edge 24 and tip portion 30, while another TE actuator 108 may be positioned adjacent trailing edge 24 and root portion 32. As similarly discussed herein with respect to FIGS. 1-4C, LE actuators 106 and TE actuators 108 may be configured to actuate and generate traveling wave 130 (see, FIGS. 4A-4C) through flexible member 110. In one non-limiting example actuators 106, 108 may actuate to generate traveling wave from first end portion 112 of flexible member 110 to second end portion 118 (e.g., leading edge 22 to trailing edge 24). In another non-limiting example, actuators 106, 108 may also actuate to generate traveling wave 130 to also flow or travel in flexible member 110 from adjacent leading edge 22 and root portion 32 to trailing edge 24 and tip portion 30. That is, in addition to traveling wave 130 flowing from first end portion 112 to second end portion 118, actuators 106, 108 may operate to have traveling way simultaneously flow from adjacent root portion 32 of airfoil 18 to tip portion 30 (e.g., diagonal flow direction).

In the non-limiting example shown in FIG. 9, wave assembly 102 may also include at least one intermediate actuator 144. Intermediate actuator 144 may be positioned between LE actuator 106 and TE actuator 108 within recess 34 (see, FIG. 3). That is, intermediate actuator 144 may be positioned within recess 34 formed in airfoil 18, and may formed or positioned downstream of LE actuator 106, and upstream of TE actuator 108. Intermediate actuator 144 may be coupled to and may interact with flexible member 110 in a similar manner as actuators 104, 106 as discussed herein. Additionally, intermediate actuator 144 may be actuated by control system 104 (see, FIG. 2) to aid in the generation of traveling wave 130 within flexible member 110, similar to LE actuator 104 shown and discussed herein with respect to FIGS. 2-4C.

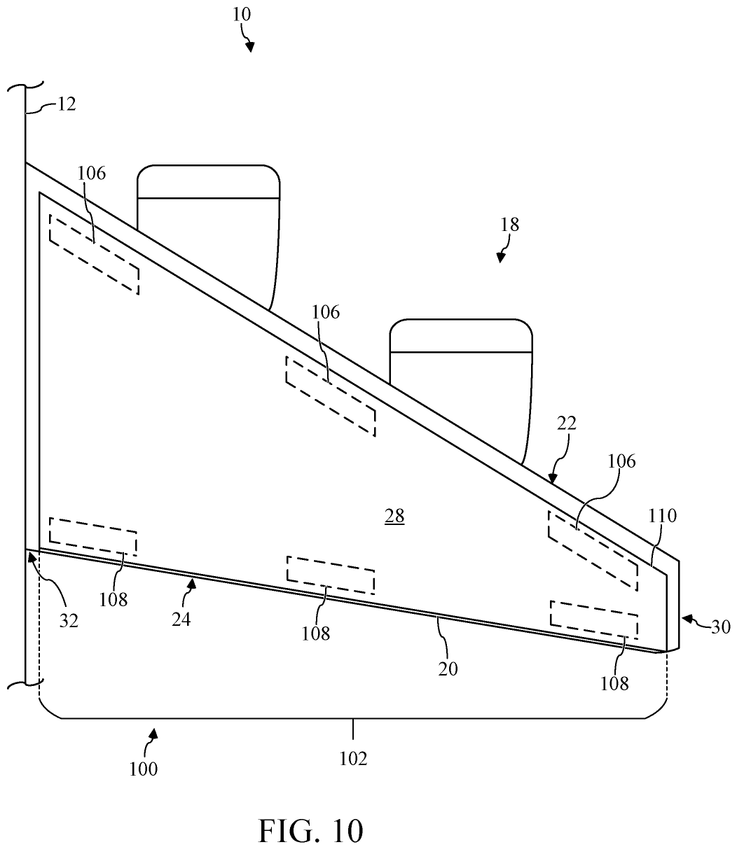

FIG. 10 shows wave assembly 102 including a plurality of actuators 106, 108. More specifically, wave assembly 102 may include three distinct LE actuators 106, and three distinct TE actuators 108. In the non-limiting example, a first LE actuator 106 may be positioned adjacent leading edge 22 and tip portion 30, a second LE actuator 106 may be positioned adjacent leading edge 22 and root portion 32, and a third LE actuator 106 may be positioned adjacent leading edge 22, between the first and the second LE actuator 106. Additionally, a first TE actuator 108 may be positioned adjacent trailing edge 24 and tip portion 30, a second TE actuator 108 may be positioned adjacent trailing edge 24 and root portion 32, and a third TE actuator 108 may be positioned adjacent trailing edge 24, between the first and the second TE actuator 108.

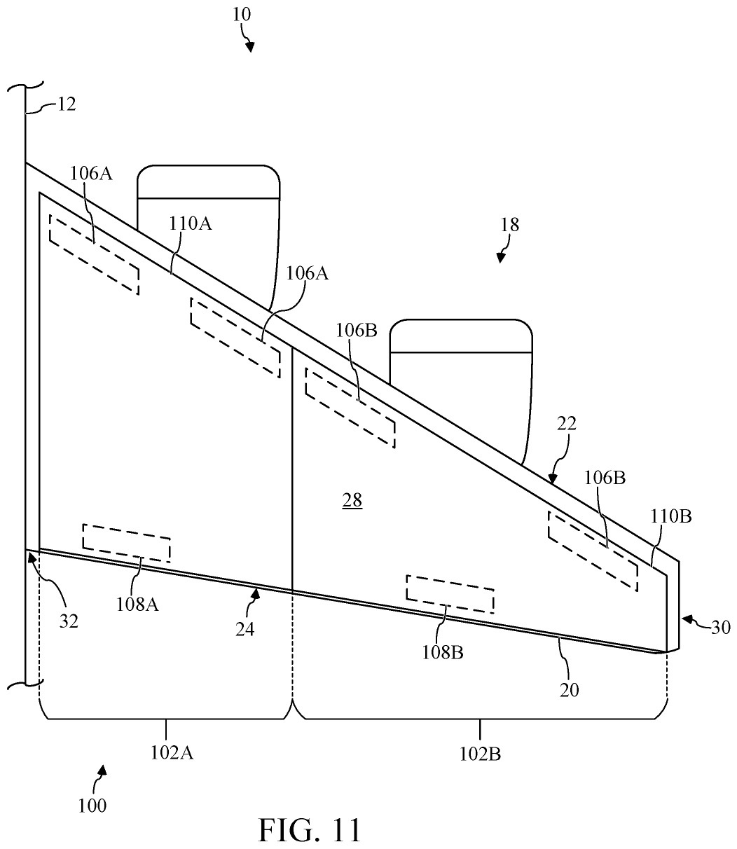

The non-limiting example shown in FIG. 11 depicts two distinct wave assemblies 102A, 102B. That is, system 100 shown in FIG. 11 may include a first wave assembly 102A positioned adjacent root portion 32 of airfoil 18, and a second, distinct wave assembly 102B positioned adjacent tip portion 30 of airfoil 18. Each of the distinct wave assemblies 102A, 102B may include two LE actuators 106A, 106B, and a single TE actuator 108A, 108B. In the non-limiting example, each wave assembly 102A, 102B may operate simultaneously, and may produce identical traveling waves 130 in each flexible member 110A, 110B. In another non-limiting example, each wave assembly 102A, 102B may operate at distinct frequencies/amplitudes/periods/wavelengths. That is, a first wave assembly 102A may generate a traveling wave 130 in first flexible member 110A at a first period/amplitude/frequency/wavelengths, while second wave assembly 102B may generate a traveling wave 130 in second flexible member 110B at a second period/amplitude/frequency/wavelengths. The second period/amplitude/frequency/wavelengths of traveling wave 130 generated in second flexible member 110B may be distinct from the first period/amplitude/frequency/wavelengths of traveling wave 130 generated in first flexible member 110A.

The non-limiting examples shown and discussed herein with respect to FIGS. 2-11 show various numbers of actuators 106, 108, 144 included in system 100. It is understood that the number of actuators 106, 108, 144 shown herein is illustrative. As such, system 100, and more specifically wave assembly 102 of system 100, may include any number of LE actuators 106, TE actuators 108, and/or intermediate actuators 144. Additionally, and as shown for example in FIG. 11, the number of LE actuators 106 included in wave assembly 102 may differ from the number of TE actuators 108. Furthermore, although shown as being positioned a predetermined distance (D1, D2) from leading edge 22/trailing edge 24, it is understood that LE actuator(s) 106 and/or TE actuator(s) 108 may be positioned and/or formed within or on leading edge 22/trailing edge 24. In these non-limiting examples flexible member 110 may extend over and/or may also be positioned on leading edge 22 and/or trailing edge 24 of airfoil 18 for aircraft 10.

FIG. 12A shows a cross-sectional view airfoil 18 for aircraft 10. More specifically, airfoil 18 shown in FIG. 12A is configured as a non-limiting example of a morphing wing that is configured to (continuously or variably) alter the geometry, tilt, angle of rotation/attack, and/or pitch of the airfoil during operation. In the non-limiting example, airfoil 18 may include a plurality of struts or supports 36 (hereafter, “struts 36”) that may support and maintain the shape of airfoil 18 during operation, but also may bend or flex upon actuation of actuators 146 of morphing wing airfoil 18. That is, struts 26 provide the necessary rigidity to maintain the shape 18, while also allowing body 20 of airfoil 18 to deform, shift, tilt, and/or change angles upon actuation of actuators 146, as discussed herein.

In the non-limiting example where airfoil 18 is formed as a morphing wing, actuators 146 may be configured to actuate, flex, and/or alter the shape of airfoil 18. That is, actuators 146 positioned within recess 34 formed between a suction side portion 148 and the remaining portion of body 20 of airfoil 18 may be configured to flex and/or bend body 20, including struts 26, to alter the shape, tilt, and/or angle of attack of airfoil 18 (e.g., takeoff, landing, cruising altitude) to improve operation. Additionally, the same actuators 146 configured to alter the shape of airfoil 18 may also be configured to form traveling wave 130 in airfoil 18. More specifically, actuators 146 may also be considered a part of wave assembly 102 for system 100. In the non-limiting example, actuators 146 may also be configured to form or generate traveling wave 130 in suction side portion 148 of body 20. Similar to flexible member 110 discussed herein with respect to FIGS. 1-4C, suction side portion 148 may be substantially flexible, and may allow a traveling wave to be formed therein and/or move through suction side portion 148 to reduce, substantially eliminate, and/or control separation of fluid from suction side 28 of airfoil 18.

Although shown as being a single, unitary body, it is understood that body 20 of airfoil 18 may be formed from a plurality of distinct sections or portions that may be connected or coupled together. For example, suction side portion 148 may be formed as distinct component from the remaining portion of body 20, and may be substantially similar to flexible member 110, as discussed herein. Additionally, or alternatively, body 20 may be formed from a leading edge portion, a trailing edge portion, and an intermediate portion formed therebetween. Each portion may extend from pressure surface 26 to suction surface 28. Each portion may be actuated by actuators 146 individually to flex, alter the geometry, tilt, angle of rotation/attack, and/or pitch airfoil 18 during operation.

FIGS. 12B and 12C show additional non-limiting examples of airfoil 18 of aircraft 10 that may be formed as a morphing wing. Additionally, the airfoils 18 shown in FIGS. 12B and 12C may utilize wave assembly 102, and at least a portion of the features of the assembly as discussed herein to generate traveling wave 130 (see, FIG. 4C) within airfoil 18.

Turning to FIG. 12B, and as similarly discussed herein with respect to FIG. 12A, actuators 146 may be configured to actuate, flex, and/or alter the shape of airfoil 18. That is, actuators 146 positioned directly on suction side 28 of airfoil 18, and positioned on/between leading edge 22 and trailing edge 24 of airfoil 18, may be configured to flex and/or bend body 20 to alter the shape, tilt, and/or angle of attack of airfoil 18 to improve operation. Additionally, the same actuators 146 configured to alter the shape of airfoil 18 may also be configured to form traveling wave 130 in airfoil 18. More specifically, actuators 146 themselves may actuated to form or generate traveling wave 130 in or on suction side portion 148 of body 20, leading edge 22 and/or trailing edge 24. Actuators 146 positioned on suction side 28 and extending at least partially between leading edge 22 and trailing edge 24 may generate traveling wave on suction side 28 of airfoil 18 to reduce, substantially eliminate, and/or control separation of fluid from suction side 28 of airfoil 18.

In the non-limiting example shown in FIG. 12C, body 20 of airfoil 18 may be formed from a plurality of distinct sections, portions, and/or segments 38 (hereafter, “segments 38”), that be coupled and/or connected via a connector or pin 40 (hereafter, “pin 40”). Each segment 38 of airfoil 18 may be substantially flexible and/or shaped/sized to flex, bend, and/or deform. Additionally, pin 40 may aid in the ability for each segment 30 to flex or bend by providing a pivot point or a rotatable-coupling configuration. Pins 40 may also be positioned within airfoil 18 body 20 to connect a plurality of links, cords, and/or cables 42 (hereafter, “cable 42”) that may be connected to at least one segment 38 of body 20 for airfoil 18. In the non-limiting example, cables 42 may be connected to various segments 38 and/or pins 40 connecting two segments 38. Additionally, cables 42 may be coupled to other cables via pins 40 and may be secured within airfoil 18 via anchors 44.

As shown in FIG. 12C, at least a portion of cables 42 may be coupled to actuators 146A, 146B of wave assembly 102. That is, at least one cable 42 may be coupled or connected to actuator 146A, and another distinct cable 42 may be coupled or connected to actuator 146B. In the non-limiting example, cables 42 connected to actuators 146A, 146B may also be connected to, either directly or via pins 40/distinct cables 42, to at least one flexible segment 38 forming body 20 of airfoil 18. As shown in FIG. 12C, actuator 146A may be connected to a segment 38 forming leading edge 22, while actuator 146B may be connected to a segment forming a portion of suction side 28 positioned between leading edge 22 and trailing edge 24. Upon actuation, actuators 146A, 146B may generate traveling wave 130 in the connected segment 38 of airfoil 18. Additionally where actuator 146A, 146B may be indirectly connected to an adjacent (or downstream) segment 38 via pins 40/cables 42, traveling wave 130 may also be generated in the adjacent segment a well. Additionally, or alternatively, pins 40 connecting adjacent segments 38 in body 20 of airfoil 18 may also aid in passing, forming, or generating traveling wave 130 through distinct segments 38. In the non-limiting example, because actuators 146A, 146B are connected to distinct segments 38 in airfoil 18, a phase lag may exist between actuators 146A, 146B during operation to prevent traveling wave 130 form being disrupted and/or reflecting back through an adjacent segment 38.

FIGS. 13A-13D show side views of various, non-limiting examples of flexible member 110 of wave assembly 102. Distinct from flexible member 110 shown and discussed herein with respect to FIG. 3 or 6-8, flexible member 110 shown in FIGS. 13A-13D do not include a uniform thickness. Rather, flexible member 110 may include a thickness (T) that varies from first end portion 112 to second end portion 118. As shown in FIG. 13A, first end portion 112 of flexible member 110 may include a first thickness (T1), while second end portion 118 of flexible member 110 may include a second, distinct thickness (T2). In the non-limiting example, first thickness (T1) may be greater and/or larger than second thickness (T2). In FIG. 13B, first end portion 112 of flexible member 110 may include the second thickness (T2), while second end portion 118 of flexible member 110 may include the first thickness (T1). FIG. 13C shows first end portion 112 and second end portion 118 of flexible member 110 each including the second thickness (T2). In the non-limiting example of FIG. 13C, a central portion of flexible member 110 formed between first end portion 112 and second end portion 118 may include the first thickness (T1). FIG. 13D shows the inverse of the flexible member 110 shown in FIG. 13C, in that first end portion 112 and second end portion 118 of flexible member 110 each including the first thickness (T1), and a central portion of flexible member 110 may include the second thickness (T2).

In the non-limiting examples shown in FIGS. 13A-13D, flexible member 110, and more specifically the thickness (T), may be axially symmetrical (e.g., axis extending from first end portion 112 to second end portion 118). In other non-limiting examples (not shown), the thickness of flexible member 110 may vary from first end portion 112 to second end portion 118, but may not be axially symmetrical. Rather, one of first surface 120 or second surface 122 may planar from first end portion 112 to second end portion 118, and the opposite surface may be non-planar and/or may include the varied thickness in flexible member 110.

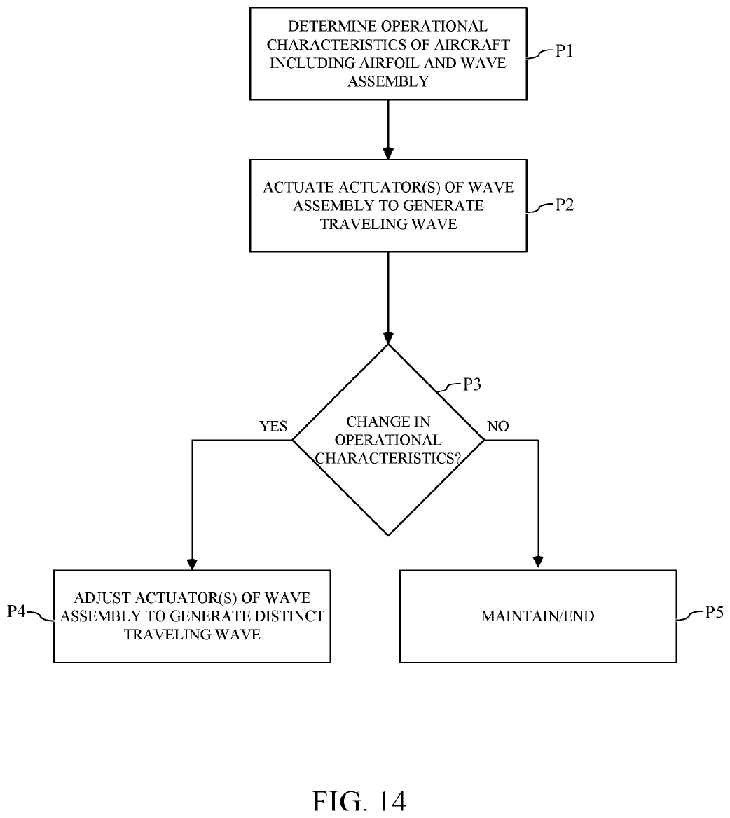

FIG. 14 depicts example processes for generating traveling waves using a wave assembly positioned on an airfoil. In some cases, a system may be used to form the thermoplastic component, as discussed above with respect to FIGS. 1-3, 7, 8, and 1-12.

In process P1, operational characteristics of an aircraft including an airfoil and a system having a wave assembly and control system used to control waver assembly may be determined. That is, the operational and/or flight characteristics/parameters for the aircraft may be determined, obtained, and/or calculated. The characteristics may be determined using a plurality of sensor, the control system controlling the wave assembly, and/or the system used to control the operation of the aircraft. The operational and/or flight characteristics/parameters include, but are not limited to, a velocity of the aircraft, an altitude of the aircraft, the flight status of the aircraft (e.g., takeoff, landing, cruising-at-altitude), an atmospheric pressure of the ambient fluid surrounding the aircraft, the size/dimensions of the airfoil for the aircraft, the geometry of the airfoil for the aircraft, movement-capabilities (e.g., angle of rotation) of the airfoil for the aircraft, and so on.

In process P2, actuator(s) of the wave assembly may be actuated. More specifically, after determining, obtaining, and/or calculating, and subsequently processing, the operational characteristics of the aircraft, actuator(s) of the wave assembly may be actuated to generate a traveling wave on the airfoil. Actuating the actuator to generate the traveling wave may also include forming the traveling wave to include a flow direction from a first end portion of the flexible member, positioned adjacent the leading edge, to a second end portion positioned adjacent the trailing edge. In a non-limiting example, the wave assembly included in the airfoil may include at least one leading edge actuator to move the flexible member. The actuated actuator(s) may come in contact with and may displace, move, and/or vibrate a flexible member of the wave assembly positioned on, adjacent, and/or at least partially planar with the suction side of the airfoil. As a result of the actuation, a traveling wave may be formed in the flexible member. The traveling wave in the flexible member may include a predetermined frequency, predetermined period, predetermined wavelength, and/or a predetermined amplitude (A), as defined by the movement or actuation of actuator(s) of the wave assembly. In a non-limiting example, the predetermined frequency, predetermined period, predetermined wavelength, and the predetermined amplitude may be based, at least in part, on the operational characteristics of the aircraft. Actuating the actuator(s) to allow the flexible member to form a traveling wave on the flexible member/suction side of the airfoil may reduce or eliminate fluid separation from the suction side of the airfoil.

Additionally, in a non-limiting example, the wave assembly may also include at least one trailing edge actuator positioned adjacent the tailing edge of the airfoil. The trailing edge actuator may be used or actuated during operation of the wave assembly to receive the traveling wave generated in the flexible member. More specifically, a trailing edge actuator may be actuated to receive the traveling wave and/or dissipate the traveling wave at a second end portion of the flexible member to prevent reflection of the traveling wave through the flexible member (e.g., traveling wave flowing from back to front).

In process P3 the operational characteristics of the aircraft are checked to determine if there has been a change. That is, a control system may determine if the operational characteristics have changed by comparing the current or real time operational characteristics to those determined in process P1 and used to determine the predetermined frequency/period/wavelength/amplitude for the traveling wave. In response to determining the operational characteristics have changed and/or are outside of a desired range and/or threshold for the characteristics (“YES” at P3), process P4 may be subsequently performed. Conversely, if the operational characteristics have not changed for the aircraft or are not outside of the desired range/fell from the threshold (“NO” at P3), process P5 may be performed.

In response to determining the operational characteristics have changed and/or are outside of a desired range and/or threshold for the characteristics (“YES” at P3), the actuator(s) of the wave assembly included within the airfoil may be adjusted. That is, in process P4, if the determined operational characteristics have changed, the operational characteristics or actuation parameters for the actuator(s) included in the wave assembly are adjusted. Adjusting the actuation of the actuator(s) may result in the generation of a distinct traveling wave through the flexible member of the wave assembly. The distinct traveling wave in the flexible member may include distinct predetermined frequency/wavelength/period/amplitude that may be dependent or based on the changed operational characteristics of the aircraft. Additionally, the distinct predetermined frequency/wavelength/period/amplitude may be distinct from the initial predetermined frequency/wavelength/period/amplitude based on the operational characteristics determined in process P1.

In response to determining the operational characteristics have not changed and/or are within a desired range and/or threshold for the characteristics (“NO” at P3), process P5 may be performed. In process P5, the traveling wave generated through the flexible member may either be maintained with the predetermined frequency/period/wavelength/amplitude, or alternatively may be stopped. Maintaining the traveling wave within the flexible member of the wave assembly, or stopping the traveling wave so the flexible member is stationary may be dependent upon the operational characteristics of the aircraft, and more specifically the flight status (e.g., takeoff, landing, cruising altitude) of the aircraft utilizing the wave assembly.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

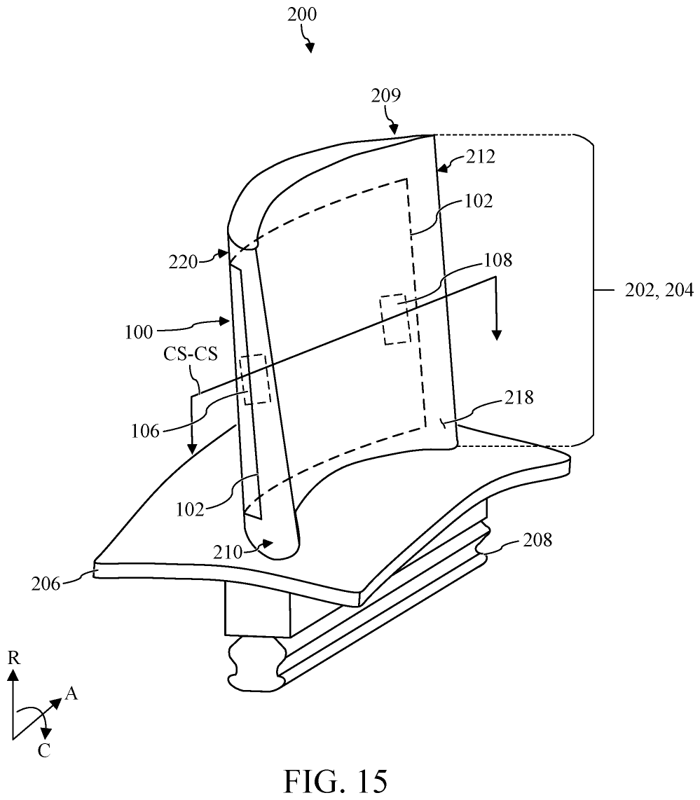

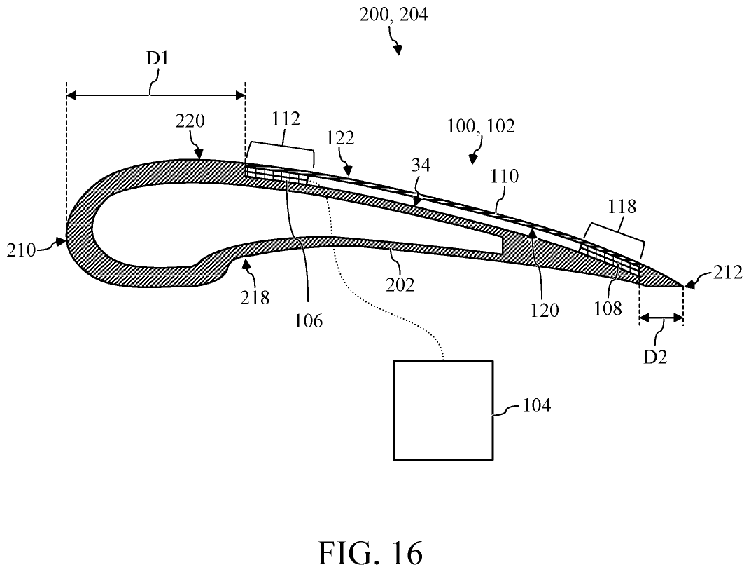

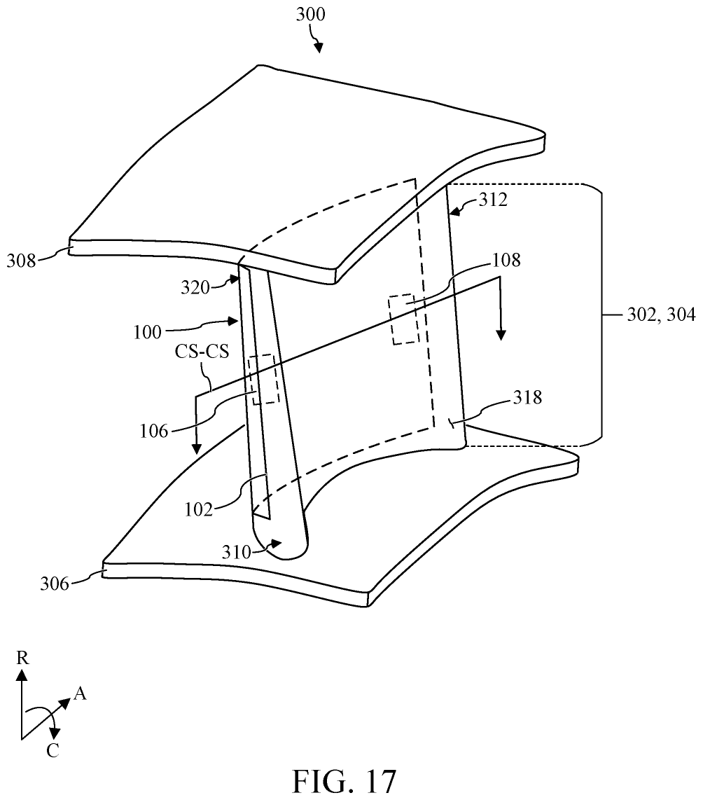

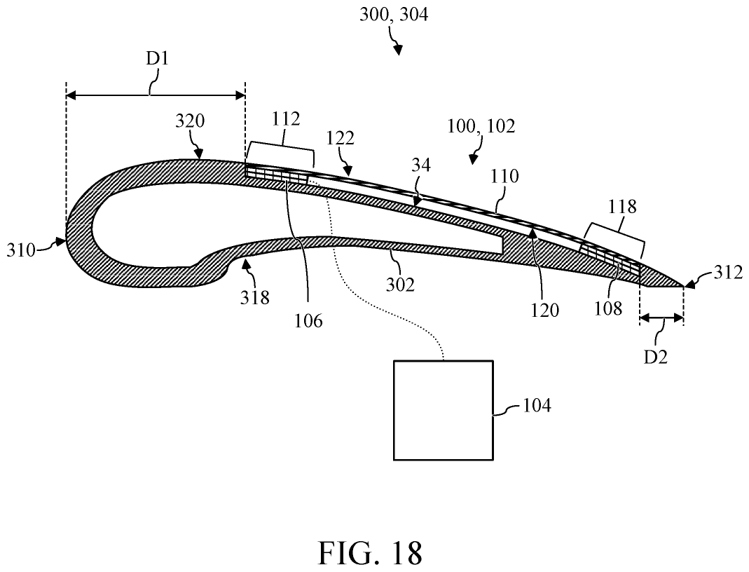

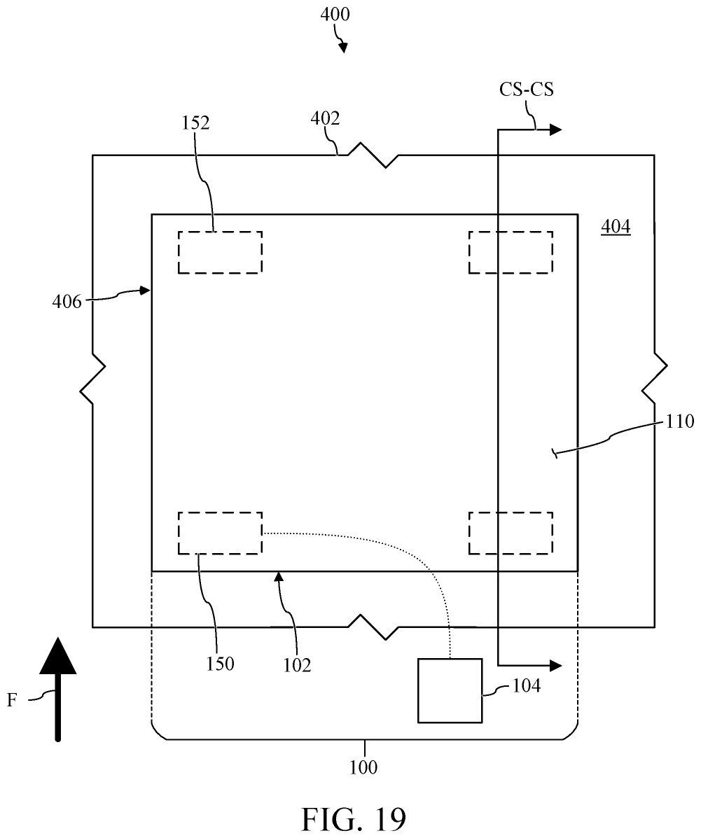

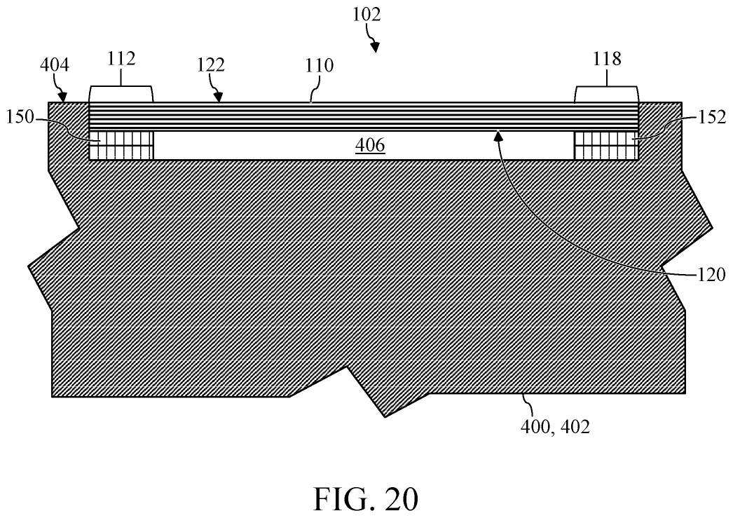

Turning to FIGS. 15-20, various views of a variety of embodiments are shown for components that may utilize system 100, as discussed herein. For example, FIGS. 15 and 16 show a turbine blade, FIGS. 17 and 18 show a stator vane, and FIGS. 19 and 20 show a component that may include any other mobile vehicle (e.g., a car, boat, etc.) as well as a wearable component (e.g., clothing). It is understood that similarly numbered and/or named components may function in a substantially similar fashion. Redundant explanation of these components has been omitted for clarity.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through the turbine engine or, for example, the flow of air through the combustor or coolant through one of the turbine's component systems. The term “downstream” corresponds to the direction of flow of the fluid, and the term “upstream” refers to the direction opposite to the flow. The terms “forward” and “aft,” without any further specificity, refer to directions, with “forward” referring to the front or compressor end of the engine, and “aft” referring to the rearward or turbine end of the engine. Additionally, the terms “leading” and “trailing” may be used and/or understood as being similar in description as the terms “forward” and “aft,” respectively. It is often required to describe parts that are at differing radial, axial and/or circumferential positions. The “A” axis represents an axial orientation. As used herein, the terms “axial” and/or “axially” refer to the relative position/direction of objects along axis A, which is substantially parallel with the axis of rotation of the turbine system (in particular, the rotor). As further used herein, the terms “radial” and/or “radially” refer to the relative position/direction of objects along an axis “R” (see, FIGS. 15-18), which is substantially perpendicular with axis A and intersects axis A at only one location. Finally, the term “circumferential” refers to movement or position around axis A (e.g., direction “C”).

Turning to FIG. 15, a perspective view of a turbine blade 200 is shown. Turbine blade 200 may be any turbine blade included in a plurality of turbine blades utilized in various portions (e.g., compressor, turbine) in a turbomachine or turbine system (not shown). In the non-limiting example, turbine blade 200 may include body 202 of airfoil 204 (hereafter, “airfoil 204”). Airfoil 204 of turbine blade 200 may be positioned and/or extend radially from a platform 206, and may be positioned radially above a shank 208 positioned and/or extend radially below platform 206. Additionally, airfoil 204 may include a tip 209 that may be positioned radially opposite platform 206. Platform 206 and shank 208 of turbine blade 200 may be formed from any suitable material that may withstand the operational characteristics and/or attributes (e.g., combustion gases pressure, internal temperature, and so on) of a turbomachine. Additionally, platform 206 and/or shank 208 may be formed using any suitable formation and/or manufacturing technique and/or process.

Similar to airfoil 18 of aircraft 10 discussed herein with respect to FIGS. 1-3, turbine blade 200, and more specifically airfoil 204, may include a leading edge 210, and a trailing edge 212 positioned opposite leading edge 210. Additionally, body 202 of airfoil 204 may include a pressure side 218 extending between leading edge 210 and trailing edge 212, as well as a suction side 220 extending between leading edge 210 and trailing edge 212. Suction side 220 may be positioned and/or formed circumferentially opposite pressure side 218. During operation of the turbine system (not shown) utilizing turbine blade 200, fluid (e.g., air) may flow over airfoil 204, and may initially flow over or contact leading edge 210. The fluid may continue to flow over pressure side 218 and suction side 220, respectfully, before being discharged from and/or off trailing edge 212. This in turn may rotate the shaft or rotor of the turbine assembly in which turbine blade 200 is coupled to. Similar to airfoil 18 of aircraft 10, the fluid flowing over airfoil 204 of turbine blade 200 may experience separation, for example, on suction side 220, which may degrade operation or performance of the turbine system, and in some cases may result in a stall event within the turbine system.

To reduce, eliminate, and/or control separation within the turbine system, and more specifically on airfoil 204, turbine blade 200 may also include system 100. Turning to FIG. 16, with continued reference to FIG. 15, turbine blade 200 is shown including system 100. As similarly discussed herein, system 100 may include wave assembly 102 and control system 104 (see, FIG. 16). In a non-limiting example, turbine blade 200 may be initially manufactured, built, fabricated, and/or designed to include system 100 and its various portions (e.g., wave assembly 102, control system 104). In another non-limiting example, turbine blade 200 may be modified, fitted, and/or may have system 100 installed or implemented post-manufacturing. As such, system 100 and its various portions discussed herein may be included within turbine blade 200 at an initial build or manufacturing stage, or alternatively may be installed or retrofitted into an existing (e.g., previously built) turbine blade 200.

Wave assembly 102 of system 100 may be formed and/or positioned on and/or adjacent suction side 220 of airfoil 204. Additionally, and as shown in FIGS. 15 and 16, wave assembly 102 of system 100 may be formed and/or position substantially between leading edge 210 and trailing edge 212, as well as substantially between tip 209 and (adjacent) platform 206 of turbine blade 200, respectively. Wave assembly 102 of system 100 may include at least one flexural actuator. In the non-limiting example shown in FIG. 16, wave assembly 102 included within turbine blade 200 may include at least one leading edge (LE) flexural actuator 106 (hereafter, “LE actuator(s) 106”) and at least one trailing edge (TE) flexural actuator 108 (hereafter, “TE actuator(s) 108”). LE actuator(s) 106 may be formed and/or positioned adjacent to and downstream of leading edge 210 of airfoil 204. In a non-limiting example, LE flexural actuator 106 may be formed and/or positioned on/within suction side 210 of airfoil 204, adjacent from, axially downstream of, and at a predetermined distance (D1) from leading edge 210 of airfoil 204 as well. The predetermined distance (D1) may be based on, at least in part, a plurality of airfoil 204 characteristics and/or operational characteristics of turbine blade 200/turbine system (not shown).

TE actuator(s) 108 may be substantially similar to LE actuator(s) 106, as discussed herein. For example, TE actuator(s) 108 may be formed and/or positioned adjacent to and upstream of trailing edge 212 of airfoil 204. In a non-limiting example, TE actuator 108 may be formed and/or positioned on/within suction side 210 of airfoil 204, adjacent from, axially upstream of, and at a predetermined distance (D2) from trailing edge 212 of airfoil 204 as well. The predetermined distance (D2) may be based on, at least in part, a plurality of airfoil 204 characteristics and/or operational characteristics of turbine blade 200/turbine system (not shown).

LE actuator(s) 106 and TE actuator(s) 108 may be coupled, secured, and/or affixed to airfoil 204 of turbine blade 200. In a non-limiting example shown in FIG. 16, body 202 of airfoil 204 may include recess 34 formed at least partially through and in at least a portion of suction side 220. Recess 34 may be formed at least partially through suction side 220 between leading edge 210 and trailing edge 212, respectively. Recess 34 formed in airfoil 204 may receive actuator(s) 106, 108 and/or actuator(s) 106, 108 may be seated in, positioned within, and/or affixed to recess 34 of airfoil 204. In the non-limiting example shown in FIG. 16, actuator(s) 106, 108 may be positioned entirely within recess 34 such that in an “off” or inoperable state (e.g., FIG. 16), no portion of actuator(s) 106, 108 may extend above and/or beyond suction side 220 of airfoil 204. Actuator(s) 106, 108 may be coupled to, secured within, and/or affixed to airfoil 204, and more specifically recess 34, using any suitable coupling component and/or technique. For example, actuator(s) 106, 108 may be coupled or affixed within recess 34 using an adhesive, form a weld or braze, mechanical fastener(s) (e.g., rivets, bolts, screws, etc.), and the like.

Actuator(s) 106, 108 of wave assembly 102 may be formed as any suitable actuator or actuation device that may form or be configured to form a traveling wave in a flexible member of wave assembly 102, as discussed herein. In non-limiting examples, actuator(s) 106, 108 may be formed as a flexural actuator, flexure-guided actuator, and/or flextensional actuators. The flexural actuator forming actuator(s) 106, 108 may be formed, for example, as a piezoelectric or Piezo flexure actuator. As discussed herein, flexural actuator(s) may be actuated by supplying a voltage thereto, and in turn may move, displace, and/or vibrate a flexible member of the wave assembly 102 to form a traveling wave on airfoil 204 during operation of turbine blade 200 turbine system (not shown). In other non-limiting examples, actuator(s) 106, 108 may be formed from any other suitable actuator or actuating device that may be configured to form a traveling wave on airfoil 204 as discussed herein. Suitable actuators may include, but are not limited to, mechanical actuators, pneumatic actuators, hydraulic actuators, electric actuators, and/or spring actuators. Additionally, although a single LE actuator(s) 106 and TE actuator(s) 108 is shown in FIG. 16, it is understood that wave assembly 102 of system 100 may include more actuator(s) 106, 108. In this non-limiting example, actuator(s) 106, 108 may be positioned and spaced radially apart throughout airfoil 204 between platform 206 and tip 209.

As shown in FIGS. 15 and 16, wave assembly 102 of system 100 may also include at least one flexible member 110. Flexible member 110 of wave assembly 102 may be actuated and/or displaced by LE actuator(s) 106/TE actuator(s) 108 to generate a traveling wave on or in airfoil 204 during operation, as discussed herein. In a non-limiting example shown in FIG. 16, flexible member 110 may include a first end portion 112 positioned adjacent to and downstream of leading edge 210 of airfoil 204. As shown in FIG. 16, first end portion 112 of flexible member 110 may be coupled, secured, and/or affixed to LE actuator(s) 106 of wave assembly 102. First end portion 112 of flexible member 110 may be coupled, secured, and/or affixed to LE actuator(s) 106 using any suitable coupling technique and/or component. For example, first end portion 112 of flexible member 110 may be adhered directly to LE actuator(s) 106. A first end of flexible member 110 included in first end portion 112 may be coupled, secured, and/or affixed to LE actuator(s) 106, or alternatively, may be coupled, secured, and/or affixed to a portion of airfoil 204 — for example a side wall of recess 34.

Flexible member 110 of wave assembly 102 may also include a second end portion 118 positioned and/or formed opposite first end portion 112. Second end portion 118 may also be positioned and/or formed adjacent to and upstream of trailing edge 212 of airfoil 204. As shown in FIG. 16, second end portion 118 of flexible member 110 may be coupled, secured, and/or affixed to TE actuator(s) 108 of wave assembly 102. Second end portion 118 of flexible member 110 may be coupled, secured, and/or affixed to TE actuator(s) 108 using any suitable coupling technique and/or component. For example, second end portion 118 of flexible member 110 may be adhered directly to TE actuator(s) 108. In other non-limiting examples, second end portion 118 may be coupled, secured, and/or affixed to airfoil 204, as similarly discussed herein with respect to FIGS. 6-8. A second end of flexible member 110 included in second end portion 118 may also be coupled, secured, and/or affixed to TE actuator(s) 108, or alternatively, may be coupled, secured, and/or affixed to a portion of airfoil 204 (e.g., side wall of recess 34).

Flexible member 110 may also include a first surface 120 extending between first end portion 112 and second end portion 118. In the non-limiting example shown in FIG. 16, first surface 120 of flexible member 110 may be affixed to and/or directly contact LE actuator(s) 106 and TE actuator(s) 108 of wave assembly 102. Additionally, first surface 120 may be positioned within and/or may face recess 34 formed in airfoil 204 and may not be exposed to ambient fluid flowing over airfoil 204 during operation of turbine blade 200 including wave assembly 102.

Flexible member 110 may also include a second surface 122. Similar to first surface 120, second surface may extend between first end portion 112 and second end portion 118 of flexible member 110, opposite first surface 120. Second surface 122 of flexible member 110 may be exposed on airfoil 204, and/or may be positioned opposite a recess 34 of airfoil 204. As such in the non-limiting example, fluid flowing over airfoil 204 during operation of turbine blade 200 may flow directly over and/or may contact second surface 122 of flexible member 110. As shown in FIG. 16, at least a portion of second surface 122 of flexible member 110 formed adjacent first end portion 112 may be in (planar) alignment with suction side 220 of airfoil 204. That is, at least a portion of second surface 122 may be substantially aligned, with, co-planar, and/or level with the surface of suction side 220 of airfoil 204 positioned upstream of flexible member 110, such that second surface 122 is even and/or flush with the surface of suction side 220 while wave assembly is inoperable and/or flexible member 110 is in an unexcited-state.

As shown in FIG. 16, flexible member 110 may also be substantially positioned and/or housed within recess 34 formed in airfoil 204. Additionally, and as similarly discussed herein with respect to FIGS. 4A-4C, a space defined by recess 34, and formed between LE actuator(s) 106 and TE actuator(s) 108) may receive moving, bending, oscillating, and/or excited flexible member 110 when a traveling wave is formed thereon (see, FIG. 4C). Flexible member 110 may be formed from any suitable flexible material and/or component that may also withstand the stresses and/or strains imparted on the member during operation or flight of turbine blade 200. In non-limiting examples, flexible member 110 may for formed from metal or metal-alloy material. In other non-limiting examples, flexible member 110 may for formed from polymer, graphene, carbon-fiber, shape memory alloy, or any other suitable material having similar elastic and strength characteristics or properties. In the non-limiting example, flexible member 110 is shown to include a uniform thickness. However, it is understood that flexible member may have a varying or variable thickness extending from first end portion 112 to second end portion 118 (see, FIGS. 13A-13D).

FIG. 17 shows a perspective view of a stator vane 300. Stator vane 300 may be any stator vane or component included in a plurality of stator vanes or assembly utilized in various portions (e.g., compressor, turbine) in a turbomachine or turbine system (not shown). Similar to turbine blade 200 of FIGS. 15 and 16, stator vane 300 shown in FIGS. 17 and 18 may include body 302 of airfoil 304 (hereafter, “airfoil 304”). Airfoil 304 of stator vane 300 may be positioned and/or extend radially between an inner shroud 306 and an outer shroud 308 coupled to a housing or casing of a turbine system. As such, outer shroud 308 may be positioned radially above inner shroud 306 and airfoil 304, respectively, and/or may be positioned radially opposite inner shroud 306.

Similar to airfoil 204 of turbine blade 200 discussed herein with respect to FIGS. 15 and 16, stator vane 300, and more specifically airfoil 304, may include a leading edge 310, and a trailing edge 312 positioned opposite leading edge 310. Additionally, body 302 of airfoil 304 may include a pressure side 318 extending between leading edge 310 and trailing edge 312, as well as a suction side 320 extending between leading edge 310 and trailing edge 312. Suction side 320 may be positioned and/or formed circumferentially opposite pressure side 318. During operation of the turbine system (not shown) utilizing stator vane 300, fluid (e.g., air, compressed air, combusted gases, and so on) may flow over airfoil 304, and may initially flow over or contact leading edge 310. The fluid may continue to flow over pressure side 318 and suction side 320, respectfully, before being discharged from and/or off trailing edge 312. Similar to airfoils 18, 204, the fluid flowing over airfoil 304 of stator vane 300 may experience separation, for example, on suction side 320, which may degrade operation or performance of the turbine system, and in some cases may result in a stall event within the turbine system.

To reduce, eliminate, and/or control separation within the turbine system, and more specifically on airfoil 304, stator vane 300 may also include system 100. Airfoil 304 of stator vane 300 may be shaped, formed, and/or configured in a substantially similar manner as airfoil 204 of turbine blade 200. For example, and with comparison of the cross-sectional views shown in FIGS. 16 and 18, airfoil 304 for stator vane 300 may be substantially similar or identical to airfoil 204 of turbine blade 200. As such, the implementation, configuration, and relationships between system 100 (and its components—wave assembly 102, control system 104) and stator vane 300 may be similar to that of system 100 and turbine blade 200 as discussed herein with respect to FIGS. 15 and 16. As such, redundant explanation of these components, and there operational functions and/or relations have been omitted for clarity and brevity.

FIGS. 19 and 20 depict another non-limiting example of a component 400 that may utilize system 100. Component 400 may be any device, system, apparatus, and/or item that may benefit from the reduction, elimination, and/or control of fluid separation during the operation or travel of the component by utilizing or implementing system 100 therein. In non-limiting examples, component 400 may include an automobile (e.g., car, truck, tractor-trailer, race car, and the like), an aquatic vehicle (e.g., boat, submarine, and the like), cabin 12 of aircraft 18 (see, FIG. 1), other vehicles (e.g., motorcycle, bicycle, skateboard, surfboard, etc.) and/or a wearable item (e.g., helmet, protective gear, clothing, shoes, and so on).

In the non-limiting example shown in FIGS. 19 and 20, component 400 may include a body 402 forming an exterior structure of component 400. Body 400 of component 400 may include an exposed surface 404. During operation or travel, exposed surface 404 may come in direct contact with a fluid (e.g., air, water, mud, oil, gas mixture, lubricants, and the like) flowing over component 400. That is, a fluid may flow in a direct (F), for example, over and may also contact exposed surface 404 of body 402 during operation of component 400. Body 402 of component 400 may also include a recess 406. Recess 406 may be formed through exposed surface 404 of component 400. More specifically, recess 406 may extend or be formed through exposed surface 404, and may at least partially extend into body 402 of component 400, adjacent exposed surface 404. As discussed herein, recess 406 may house or receive portions of wave assembly 102 of system included in component 400.

In the non-limiting example shown in FIGS. 19 and 20, component 400 may include system 100, and more specifically wave assembly 102 and control system 104 (see, FIG. 19). Wave assembly 102 and control system 104 may be included in and function during operation substantially similarly to wave assembly 102 and control system 104 discussed herein with respect to FIGS. 1-12 and 15-18, respectively. It is understood that similarly numbered and/or named components may function in a substantially similar fashion.

As shown in FIGS. 19 and 20, wave assembly 102 may include at least one first end flexural actuator 150 (hereafter, “first end actuator 150”) and at least one second end flexural actuator 152 (hereafter, “second end actuator 152”). In the non-limiting example, first end actuator(s) 150 may be positioned more closely to the direction of fluid flow (F) flowing over component 400. As such, the fluid flowing over component 400 may flow over and/or adjacent first end actuator(s) 150 prior to flowing toward, over, and/or adjacent second end actuator(s) 152. First end actuator(s) 150 may be substantially similar to LE actuator(s) 106 discussed herein. Additionally, second end actuator(s) 152 may be substantially similar to TE actuator(s) 108 discussed herein. Wave assembly 102 shown in the non-limiting example may also include flexible member 110—which is also substantially similar to flexible member 110 discussed herein with respect to FIGS. 1-4C and 15-18, respectively. Redundant explanation of these components has been omitted for clarity.

As shown in FIGS. 19 and 20, first end actuator(s) 150 and second end actuator(s) 152 may be coupled, secured, and/or affixed to body 402 of component 400. In a non-limiting example shown in FIG. 20, recess 406 formed in component 400 may receive actuator(s) 150, 152 and/or actuator(s) 150, 152 may be seated in, positioned within, and/or affixed to recess 406 of component 400. In the non-limiting example shown in FIG. 20, actuator(s) 150, 152 may be positioned entirely within recess 406 such that in an “off” or inoperable state (e.g., FIG. 20), no portion of actuator(s) 150, 152 may extend above and/or beyond exposed surface 404 of component 400. In other non-limiting examples, at least a portion of actuator(s) 150, 152 may extend above or beyond exposed surface 404 of component 400 where the extension of actuator(s) 150, 152 does not detrimentally affect the flow of fluid over exposed surface 404 of component 400. Actuator(s) 150, 152 may be coupled to, secured within, and/or affixed to body 402, and more specifically recess 406, using any suitable coupling component and/or technique. For example, actuator(s) 150, 152 may be coupled or affixed within recess 406 using an adhesive, form a weld or braze, mechanical fastener(s) (e.g., rivets, bolts, screws, etc.), and the like. As similarly discussed herein, actuator(s) 150, 152 may be actuated to generate a traveling wave 130 within or through flexible member 110 positioned adjacent to exposed surface 404 and/or on component 400.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. An airfoil for an aircraft, the airfoil comprising:
a body including:
a leading edge,
a trailing edge position opposite the leading edge,
a pressure side extending between the leading edge and the trailing edge, and
a suction side extending between the leading edge and the trailing edge, the suction side positioned opposite the pressure side; and
a wave assembly positioned on the suction side of the body, the wave assembly including:
at least one leading edge flexural actuator positioned adjacent the leading edge of the body, and
a flexible member including a first end portion affixed to the at least one leading edge flexural actuator, and a second end portion positioned opposite the first end portion, and adjacent the trailing edge of the body.

2. The airfoil of claim 1, wherein the wave assembly further includes:
at least one trailing edge flexural actuator positioned adjacent the trailing edge of the body.

3. The airfoil of claim 2, wherein the second end portion of the flexible member is affixed to the at least one trailing edge flexural actuator.

4. The airfoil of claim 1, wherein the body further includes:
a tip portion; and
a root portion positioned opposite the tip portion, the root portion extending between the leading edge and trailing edge, respectively, and coupled directly to a cabin of the aircraft.

5. The airfoil of claim 4, wherein the wave assembly further includes at least one of:
a first stiffening component coupled to the flexible member, adjacent the first end portion, the first stiffening component extending at least partially between the tip portion and the root portion of the body; or
a second stiffening component coupled to the flexible member, adjacent the second end portion, the second stiffening component extending at least partially between the tip portion and the root portion of the body.

6. The airfoil of claim 1, wherein a thickness of the flexible member of the wave assembly varies from the first end portion to the second end portion.

7. The airfoil of claim 1, wherein the body further includes a recess formed in the suction side, the recess receiving the at least one leading edge flexural actuator and at least a portion of the flexible member of the wave assembly.

8. The airfoil of claim 7, wherein the second end portion of the flexible member is one of:
coupled to the suction side of the body, adjacent the trailing edge, or
coupled within the recess formed in the suction side of the body.

9. The airfoil of claim 1, wherein the flexible member of the wave assembly further includes:
a first surface extending between the first end portion and the second end portion, the first surface affixed to the at least one leading edge flexural actuator; and
a second surface extending between the first end portion and the second end portion, opposite the first surface, at least a portion of the second surface formed adjacent the first end portion in alignment with the suction side of the body.

10. A system used in an airfoil of an aircraft, the system comprising:
a wave assembly positioned on a suction side of the airfoil, the suction side extending between a leading edge and a trailing edge of the airfoil,
wherein the wave assembly includes:
at least one leading edge flexural actuator positioned adjacent the leading edge of the airfoil, and
a flexible member including a first end portion affixed to the at least one leading edge flexural actuator, and a second end portion positioned opposite the first end portion, and adjacent the trailing edge of the airfoil; and
a control system in communication with the wave assembly, the control system configured to:
actuate the at least one leading edge flexural actuator to generate a traveling wave through the flexible member, the traveling wave including a predetermined frequency and a predetermined amplitude based on operational characteristics of the aircraft.

11. The system of claim 10, wherein the wave assembly further includes:
at least one trailing edge flexural actuator positioned adjacent the trailing edge of the airfoil,
wherein the second end portion of the flexible member is affixed to the at least one trailing edge flexural actuator.

12. The system of claim 11, wherein the control system is in electronic communication with the at least one leading edge flexural actuator and the at least one trailing edge flexural actuator, respectively, and the control system in configured to:
actuate the at least one leading edge flexural actuator and the at least one trailing edge flexural actuator to generate the traveling wave through the flexible member.

13. The system of claim 10, wherein the flexible member of the wave assembly further includes:
a first surface extending between the first end portion and the second end portion, the first surface affixed to the at least one leading edge flexural actuator; and
a second surface extending between the first end portion and the second end portion, opposite the first surface, at least a portion of the second surface formed adjacent the first end portion is in alignment with the suction side of the airfoil.

14. The system of claim 10, wherein a thickness of the flexible member of the wave assembly varies from the first end portion to the second end portion.

15. The system of claim 10, wherein the control system is configured to:
detect a change in the operational characteristics of the aircraft; and
adjust the actuation of the at least one leading edge flexural actuator to generate a distinct traveling wave through the flexible member, the distinct traveling wave including a distinct, predetermined frequency and a distinct, predetermined amplitude based on the detected change in the operational characteristics of the aircraft.

16. A method comprising:
determining operational characteristics of an aircraft, the aircraft including an airfoil having:
a wave assembly positioned on a suction side of the airfoil, the suction side extending between a leading edge and a trailing edge of the airfoil,
wherein the wave assembly includes:
at least one leading edge flexural actuator positioned adjacent the leading edge of the airfoil, and
a flexible member including a first end portion affixed to the at least one leading edge flexural actuator, and a second end portion positioned opposite the first end portion, and adjacent the trailing edge of the airfoil; and
actuating the at least one leading edge flexural actuator to generate a traveling wave through the flexible member, the traveling wave including a predetermined frequency and a predetermined amplitude based on operational characteristics of the aircraft.

17. The method of claim 16, further comprising:
actuating at least one trailing edge flexural actuator to generate the traveling wave through the flexible member, the at least one trailing edge flexural actuator positioned adjacent the trailing edge of the airfoil.

18. The method of claim 16, wherein actuating the at least one leading edge flexural actuator to generate the traveling wave further includes:
forming the traveling wave to include a flow direction from the first end portion of the flexible member to the second end portion of the flexible member.

19. The method of claim 16, further comprising:
dissipating the traveling wave at the second end portion of the flexible member to prevent reflection of the traveling wave through the flexible member.

20. The method of claim 16, wherein the operational characteristics of the aircraft including at least one of:
a velocity of the aircraft,
an altitude of the aircraft,
an atmospheric pressure of the ambient fluid surrounding the aircraft,
a size of the airfoil,
a geometry of the airfoil, and
an angle of rotation of the airfoil.

21. A component comprising:
a body including:
an exposed surface, and
a recess formed through the exposed surface; and
a wave assembly positioned on the exposed surface of the body, the wave assembly including:
at least one first end flexural actuator positioned within the recess of the body, and
a flexible member including a first end portion affixed to the at least one first end flexural actuator, and a second end portion positioned opposite the first end portion.

22. The component of claim 21, wherein the wave assembly further includes:
at least one second end flexural actuator positioned within the recess of the body,
wherein the second end portion of the flexible member is affixed to the at least one trailing edge flexural actuator.
